(19) United States
(12) Patent Application Publication
(10) Pub. No.: US 2007/0192128 A1
(43) Pub. Date: Aug. 16, 2007

(54) SYSTEM AND METHOD FOR MANAGING MANUFACTURING INFORMATION

(75) Inventor: Stefano Celestini, Oakville (CA)

Correspondence Address: BERESKIN AND PARR, 40 KING STREET WEST, BOX 401, TORONTO, ON, M5H 3Y2, US

(73) Assignee: SHOPLOGIX INC., Oakville (CA)

(21) Appl. No.: 11/676,027

(22) Filed: Feb. 16, 2007

Related U.S. Application Data
(60) Provisional application No. 60/773,646, filed on Feb. 16, 2006.

(51) Int. Cl. G06Q 10/00

(52) U.S. Cl. 705/1

(57) ABSTRACT

A system for managing data within an organization that is intended to provide tactical and/or role-based data. The system includes a data acquisition module, a data processing module and an output module. The data acquisition module acquires operational data and financial data related to the operational data. The data processing module is configured to: analyze the operational data to identify a variance in the operational data; determine a financial impact of the variance based on the financial data; generate an event based on the variance in the operational data; and prioritize the event based on the financial impact. The output module then outputs the event, preferably in accordance with priority. In a particular case, the event may also be categorized as relating to a particular role with the organization.

### RELATED APPLICATIONS

This application claims the benefit of U.S. Provisional Patent Application No. 60/773,646, filed Feb. 16, 2006, which is hereby incorporated herein by reference.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The present document relates to a system and method for managing manufacturing information, more particularly, to systems, structures and methods of providing tactical role-based information based on computer assisted monitoring, processing, and reporting on the status and performance of machines in a manufacturing environment.

### BACKGROUND

Most organizations are made up of people working in various roles, for example, a manufacturing company may include roles such as maintenance, quality control, purchasing and so forth. The work done by each of the people in these various roles can have a greater or lesser impact on other roles and also on the general wellbeing of the organization. The more information available to each of these people, the greater their ability to perform their tasks in a manner that is in accordance with the needs of the organization.

There are currently a wide variety of methods and systems intended to provide data to various people within an organization. These conventional systems and methods operate by monitoring various inputs and operating metrics within the organization.

These conventional systems and methods may include the monitoring and storing of data with respect to machines in manufacturing, production and processing environments such as a factory. However, these conventional methods tend to focus primarily on machine operation and very little on the information that the machine can provide to others. Usually, a machine interface is designed to communicate directly to an operator of the machine equipment. It provides the operator with the information necessary to run the machine and make changes to the machine as needed. If one wishes to collect and analyze machine productivity, maintenance, status, quality, signal, or alarm information in real-time or over an interval of time, this information is either not available or needs to be derived from raw signals. The usual way to collect such information is manually by the operator. This implies a number of disadvantages. Typically, an operator must be present at all times to monitor the machine and the information collected is either recorded manually on paper or manually entered into a computer on the factory floor. Thus, it is possible that only a fraction of the useful information will be captured. Further, due to the high-level of human interaction required, this method is also prone to inaccuracies. In addition, the necessity of human interaction introduces delays that make this approach unsuitable for real time-decision making.

Other solutions for automated data collection and reporting involve a more complicated integration effort and rely on the machine data being stored in a database on a central server on a network. However, in these solutions machine data must constantly be sent to the central server for processing. Thus, such solutions may require additional network resources and may increase network congestion. Further, should the central server or network fail, valuable machine data will be lost; consequently, monitoring and some level of control will be jeopardized. In addition, the network, central server, and machine connections may all have to be configured separately through a variety of interfaces, which may increase configuration time and complexity both during initial installation and recovery after failure of a system component.

Furthermore, there are a number of potential problems with these systems and methods, including the following issues. First, they often only provide raw data, which may not be meaningful to a particular person in a particular role. This means that the person must spend time and effort in converting the data into information that he/she can use. Second, even if the data is processed, it is often not processed in such a way so as to turn it into information that is meaningful to a person in a specific role. Third, the data or information provided is usually not real time data. Fourth, the data provided is often commingled with data not relevant to the person. This can create more harm than good in that the person can become distracted and frustrated by the amount of data irrelevant to them. Fifth, the data provided is often too narrow in that it only takes into account data generated in the immediate vicinity of the person reviewing the data. Further, the data is often presented in formats that are difficult to read or analyze effectively.

Thus, there is a need for a method and system for better managing manufacturing data and information and, in particular, to provide better tactical role-specific information.

### SUMMARY

Accordingly, at least some of the embodiments described herein are intended to provide a system and method that automatically monitors machines and captures operational data, which may then be processed and combined with financial data so that the combined data can be reported in a manner configurable by the user such that it provides tactical information (i.e. prioritized information taking into account both operational and financial data) that can be analyzed at various levels of detail. Preferably, the tactical information may also be categorized based on roles within an organization. The system and method is intended to allow for viewing of reports in a variety of formats and is also intended to provide a distributed data processing and storage structure.

According to a first aspect, there is provided a system for managing data within an organization, the system including: a data acquisition module for acquiring operational data and financial data related to the operational data; a data processing module configured to: analyze the operational data to identify a variance in the operational data; determine a financial impact of the variance based on the financial data; generate an event based on the variance in the operational data; and prioritize the event based on the financial impact; and an output module for outputting the event.

In some cases, the financial data may be data relating to opportunity costs and/or data relating to margins.

In a particular case, the financial impact may be determined by applying the financial data to the operational data and calculating a value attributable to the variance in the operational data.

In another particular case, the data acquisition module may acquire financial data for a task at the time the task is scheduled.

In yet another particular case, the output module may output the events in accordance with the prioritization.

In yet another particular case, the operational data is real-time operational data and the data processing module operates on the real-time operational data.

In yet another particular case, the data processing module is further configured to categorize the event as relating to a role within the organization.

In still yet another particular case, the data processing module includes a rules processing module that applies rules to the operational data and financial data to identify the variances and to determine the financial impact. In particular, the rules may relate to the operational data and financial data by making reference to particular operational variables or financial variables.

In this particular case, the rules may include information relating to roles within the organization. Further, the system may include a configuration module for entry of the rules and the roles.

According to another aspect, there is provided a method for managing data within an organization, the method including: acquiring operational data relating to operations of the organization; acquiring financial data related to the operational data; automatically analyzing the operational data and the financial data to: identify a variance in the operational data; generate an event based on the variance; determine a financial impact of the variance based on the variance and the financial data; and prioritize the event based on the financial impact; and outputting the events.

In a particular case, the analyzing may further include categorizing the event as relating to a role within the organization.

In another particular case, the analyzing may include applying rules to the operational data and financial data to identify the variance and to determine the financial impact.

In this case, the rules may include information relating to the roles within the organization and the event may be categorized as being related to a role within the organization. In this case, the method may also include entering configuration data, including rules and roles.

According to yet another aspect, there is provided a graphical user interface for role-based information, the user interface including a plurality of icons each representing a role within an organization, wherein each icon is selectable to provide additional information relating to events relating to the role. In a particular case, each icon may also indicate a status for the represented role based on priority of the events for the represented role. Further, the additional information may include a list of events ranked according to a financial impact of the event on the organization.

According to yet another aspect, there is provided a graphical user interface for viewing reports including: a main window; and two or more secondary windows within the main window, each secondary window showing a single report variable, wherein each secondary window includes a means for moving the secondary window within the main window, allowing a first secondary window to be overlaid on a second secondary window in order to compare report variables.

### BRIEF DESCRIPTION OF THE FIGURES

For a better understanding of the exemplary embodiments, and to show more clearly how they may be carried into effect, reference will now be made, by way of example, to the accompanying drawings which aid in understanding and in which:

FIG. 1 is a block diagram of a system according to an embodiment;

FIG. 2 is a tree diagram illustrating an exemplary data structure in accordance with an embodiment;

FIG. 3 is a tree diagram illustrating an exemplary data structure similar to that of FIG. 2 together with exemplary data stored by each node;

FIG. 4 is a block diagram showing exemplary modules of management software for the system of FIG. 1;

FIG. 5 is a block diagram of the hardware components of an MMD;

FIG. 6 is a logical flow diagram of the software modules of the MMD.

FIG. 7 is a flowchart of a method for operating the MMD.

FIG. 8 is a flowchart of the configuration step of FIG. 7.

FIG. 9 is a flowchart of the monitoring step of FIG. 7.

FIG. 10 is a flowchart of the reporting step of FIG. 7 for automated reports.

FIG. 11 is a flowchart of the reporting step of FIG. 7 for user requested web page reports.

FIG. 12 illustrates an exemplary user-interface for reports;

FIG. 13 illustrates an exemplary inventory report;

FIG. 14 illustrates an exemplary role-based user interface;

FIG. 15 illustrates exemplary rules used by a rules processing module;

FIG. 16 illustrates exemplary events listed as a hot list;

FIG. 17 illustrates two machines operating at different levels of efficiency with assigned jobs of differing value;

FIG. 18 is a flowchart illustrating a method by which management software collects and stores data;

FIG. 19 is a flowchart illustrating a method by which the management software processes data into tactical role specific information;

FIG. 20 is a flowchart illustrating a method by which the management software outputs information on the user interface.

### DETAILED DESCRIPTION

The present disclosure deals generally with a computer-assisted system and method for managing manufacturing information. The system provides a platform for the provision of tactical role-specific (or role-based) information to people in various roles in an organization. In a general configuration, the system includes a configuration module, a data acquisition module, a rules processing module, and an output module. In the following description, an embodiment of the system configured for a manufacturing environment will be described.

In this embodiment, the system includes management software that acquires operational data and financial data related to the manufacturing operation, processes the operational data and financial data using various rules and outputs the resultant information based on roles within an organization and based on the financial importance (tactical importance) of the information.

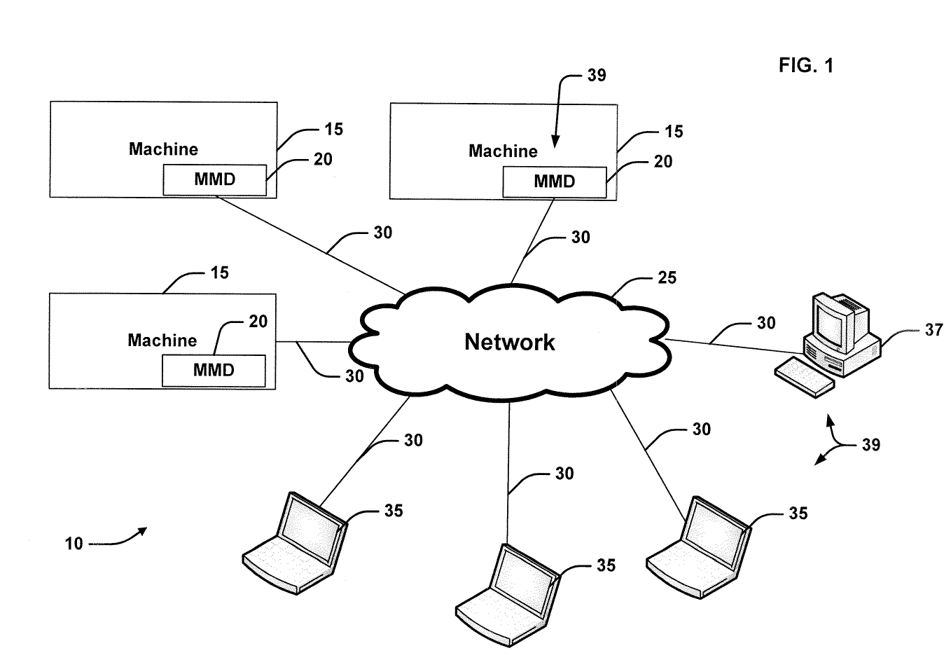

FIG. 1 is a block diagram of an embodiment of a system 10 for management of manufacturing information. The system 10 operates on a network 25 with nodes (machine monitoring devices (MMDs) 20), user devices (UDs) 35 and servers 37, each of which may be generically referred to as a computing device (CD) 39) that may be used for collecting operational data, financial data, and/or provide user access to data. The operational data is generally defined as data relating to inputs and outputs in an organization that are indicators of the operation of the business and will generally be acquired from the MMDs 20, which act as an interface between manufacturing machines 15 and users of the system 10. Operational data is further defined below by general and contextual examples. The financial data is generally defined as monetary values that may be assigned to aspects of the operation of the organization and will generally be acquired by an MMD 20 or a UD 35 but may also be input at another CD 39 on the network 25. Financial data is further defined below by general and contextual examples. User access to data (including operational and financial data) may be provided by any CD 39, which can access the network 25. The network 25 used may be a local area network, wide area network, an intranet, the Internet, wireless network, or any other suitable network type or combination of network types. The network types mentioned serve only as examples. It is not intended to restrict the embodiments to a specific network type or protocol.

As shown in FIG. 1, MMDs 20 are connectible to one or more machines 15 or may be a component of a machine 15. A machine 15 may be any of a variety of devices found in a manufacturing environment, which provides some outputs and, if desired, inputs. These outputs and inputs may include, for example, digital inputs, digital outputs, analog inputs, analog outputs, serial communications, parallel communications and network communications, such as Ethernet communications, as well as outputs that can be sensed in some fashion by the addition of sensors. As such, machines 15 may include any devices having simple digital or analog outputs, Programmable Logic Controls (PLCs), Computer Numeric Controls (CNCs), Ethernet ports, or serial ports for RS232/RS485 connections, among others. The MMD 20 may generate MMD 20 output signals, such as digital output signals or the like, in response to data received from the machine 15 and processed by the MMD 20, which may be transmitted by the MMD 20 to any machine 15 attached to an MMD 20 output connector, MMD 20 serial ports, or MMD 20 network ports. These MMD 20 output signals may be used for a variety of purposes, including, for example, pausing a machine 15, stopping a machine 15, or instructing a machine 15 to continue operation, as well as activating or deactivating user notification devices such as lights, buzzers or the like. Other types of inputs to the MMD 20 and outputs from the MMD 20 are possible. It is not intended that the input and output types and their possible uses be limited to a given connection type, communication protocol, or specific type of machine 15.

In the network 25, the MMD 20 is generally the main source of operational data related to the manufacturing environment. As described in further detail below, the MMD 20 is a compact device containing a processing engine, a server for generating displays and user interfaces, a database system, and machine and network connectivity capabilities. The MMD 20 provides machine input and output, data storage and processing, and system configuration capabilities. The MMD 20 may also provide user interface and report generation functions. The MMD 20 is intended to be a self-contained, and compact system, readily attachable to almost any machine 15. Since the MMD 20 provides self-contained data storage, processing, configuration and reporting services, it is not dependent on external computers for any of these functions, but remains capable of transmitting reports for archival storage on another CD 39 if desired, thus increasing reliability and reducing network traffic. In fact, the MMD 20 constitutes a self-contained unit that can act as a server to the other CDs 39. The other CDs 39, and in particular the UDs 35, in turn, can act as client mechanisms for remotely requesting, storing and viewing report data and remotely entering and viewing MMD 20 configuration information.

Data from the MMD 20 is transmitted over a data link 30 from the MMD 20 to the network 25 where it is transported, for example, to the UDs 35 via a data link 30 between the network 25 and the UD 35. The UD 35 may be any type of computing device 39 capable of receiving, transmitting, and displaying data in the format provided by the network 25 and the MMD 20. A UD 35 may comprise, among other devices, personal computers, handheld computers, personal data assistants (PDA), and cellular phones.

The UD 35 can be used to access the MMDs 20, for example, for remotely configuring the MMD 20, for remotely requesting and viewing reports from the MMD 20, for receiving copies and back-ups of data, which may be in any of various formats if desired, and for manipulating data. In one embodiment, UD 35 provides a portal user interface, which simply provides a link to the MMDs such that configuration and report requesting, viewing and manipulating transactions may be carried out via user interfaces generated by the MMD 20. In particular, reports and configuration information are requested by users and displayed via user interfaces generated by the MMD 20 and transmitted to a UD 35 where the user views reports and configuration. In this case, configuration information and report request parameters can also be entered to the UD 35 via user interfaces generated by the MMD 20. Thus, the MMD 20 is capable of handling all data processing, configuration, monitoring, user interface generation, and reporting and constitutes a self-contained unit for such services. As such, the MMD 20 acts as a server to the UDs 35.

In other embodiments, the UD 35 may include a more detailed user interface for inputting requests, displaying results output by the MMD 20, archiving of data and for generally managing data. This more detailed user interface may be stored locally on the UD 35 or be downloaded when needed from other CDs 39 on the network 25 similar to the downloading of Java™, Flash™ or ActiveX™ programs within the World Wide Web.

The network 25 may further include one or more servers 37, which are in communication with the MMDs 20 and UDs 35. The server 37 may be physically similar to UD 35 or MMD 20 (and may, in some embodiments, be incorporated into a UD 35 or MMD 20). It will be understood by one of skill in the art that the MMDs 20 and UDs 35 also act as “servers” in that they may serve data and reports to other CDs 39. In this case, the server 37 refers to a CD 39 that is appropriately configured to perform a specific task within the network 25, such as data backup, data accumulation, or the like.

The data links 30 among the MMDs 20, the UDs 35 and servers 37 may be wireless data links or wire line data links, provided they can carry data in the protocol used by the CDs 39.

### Data Structure

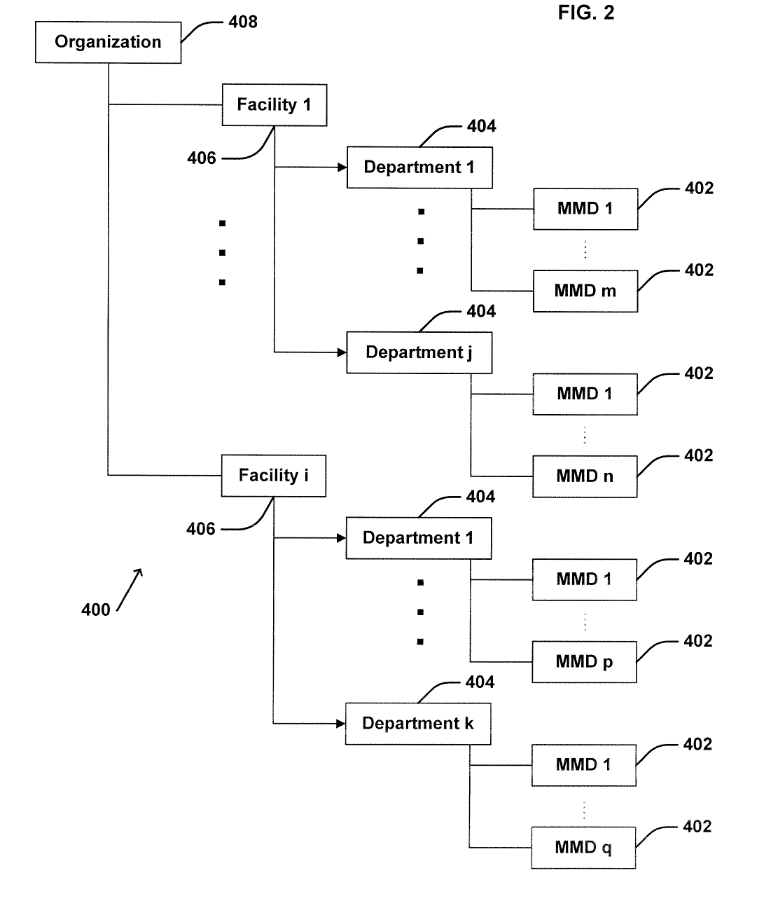

Reference is now made to FIG. 2, which is a tree diagram illustrating a data structure 400 in accordance with an exemplary embodiment. Generally, FIG. 2 illustrates a data-centric view of the system 10 of FIG. 1. The data structure 400 includes a plurality of leaf nodes 402. These leaf nodes 402 generally represent individual MMDs 20 and, as there is typically one machine 15 per MMD 20, also represent machines 15. The leaf nodes 402 are grouped together in functional or logical groups to form department nodes 404. For example, a department node 404 may represent all presses in a stamping plant or the like. Each department node 404 represents a data pool that may reside on a CD 39 that is selected to store the department node 404. The CD 39 may be an MMD 20, a UD 35 or a server 37. The particular CD 39 utilized is chosen such that it has the required processing power and networking capabilities. As such, department nodes 404 may be conveniently placed on servers 37.

The department nodes 404 are further grouped to form facility nodes 406. Each facility node 406 generally corresponds to a particular facility or plant and may reside on a CD 39 in a similar way to the department nodes 404. The facility nodes 406 may be further grouped to form an organization node 408, which is generally the root of the hierarchical structure. The organization node 408 also resides on a CD 39, and preferably a server 37. The data structure 400 illustrated in FIG. 2 has i facility nodes, j+k department nodes and m+n+p+q MMDs 20, where i, j, k, m, n, p, and q are all greater than 1. This is meant to serve as an example only. Not all the levels described need to be present and additional levels may be incorporated, as necessary. A simpler or more complicated data structure 400 is possible.

The data structure 400 resides on the network 25, through which each node in the data structure 400 can access information from any other node. As such, a user of any CD 39 on the network 25 can access information from any other CD 39 on the network 25, provided that appropriate user interfaces, security settings and the like are available. In this way, the data structure 400 is intended to generally function as a peer-to-peer network and is intended for data accumulation and serving efficiency. It will be understood that the leaf nodes 402 will generally correspond to MMDs 20 and the department nodes 404, facility nodes 406, and organization node 408 may correspond to servers 37 while UDs 35 represent user computers within the organization. However, one of skill in the art will understand that this is not necessarily the case and that a department node may alternatively be on an MMD 20 or UD 35.

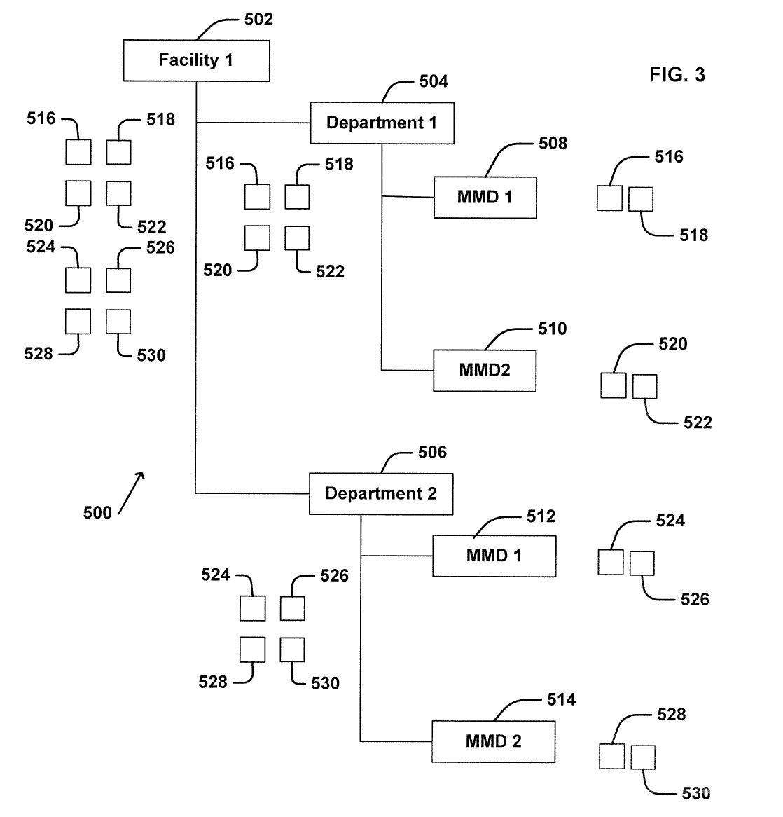

The data structure 400 can be arranged such that nodes in the system store duplicate data, both for ease of access and archival purposes. FIG. 3, in a tree diagram, illustrates an exemplary data structure similar to that of FIG. 2, further illustrating data sets stored by each node. In FIG. 3, the data structure 500 comprises a single facility node 502 and two department nodes 504 and 506. In this example, each department node 504 and 506 has only two MMD nodes 508, 510, and 512, 514, however, it will be understood that additional MMD nodes may be present. The data gathered by each of the MMD nodes 508, 510, 512, and 514 is stored in data sets. However, in order to avoid data loss, nodes in the data structure 400 may store redundant data. For example, node 508 may store data sets 516 and 518. Data sets 516 and 518 are in fact the same. Thus, if one of the data sets, such as data set 516 is corrupted, data can be recovered from another copy of the same data set, such as data set 516 at another level. Similarly, MMD node 510 stores duplicate data sets 520 and 522. Department node 504 stores all the data sets stored by all its children. The same is true for department node 506, which stores data sets 524, 526, 528 and 530, each of which are originally created by MMD nodes 512 and 514. Similarly, facility node 502 stores all the data sets stored by its children. Thus, there are multiple levels of redundancy. Further, when a particular data set is needed, the data set may be accessed from various places, similar to the way in which peer-to-peer systems have been used to allow access to a music or video file from many locations on a network. This peer-to-peer functionality may be realized by known methods, including the provision of a data manager (not shown) on a CD 39, which maintains a periodically updated list of the locations of data sets within the network.

The above-described data structure 400 has several advantages over conventional methods that utilize a central database to store information. For example, data structure 400 does not require conventional backups in order to secure the information, as there are multiple levels of redundancy. In addition, should any part of the system 10 become inaccessible or fail, a user can generally still obtain the data from another part of the system 10. Thus, delays and risk of information loss are minimized. Even if one particular node is compromised, the majority of the data can generally be recovered and restored from the information stored on either its parent or children. Similarly, even if the data for a particular department or facility is compromised, the data could be recovered from the facility or organization node respectively, provided that the particular data structure 400 has such a node.

The data structures illustrated in FIGS. 2 and 3 are shown as a hierarchy. This hierarchy is shown only from a logical (i.e. navigational and data storing and updating) point of view. The hierarchy does not need to exist from a physical (processing or control) point of view. Thus, as mentioned above, the higher nodes do not necessarily control or provide the MMDs 20 with instructions. The system 10 and data structure 400 is intended to comprise a cross-updating data structure. If any portion of the system 10 or data structure 400 is compromised there is intended to be another portion that can be used to repair it.

However, the updating process of saving duplicate data does not necessarily occur in real time. Although nodes store duplicate data, in some embodiments, it is not necessary for each parent node to be completely up-to-date and always store the same data as its children. For example, each parent node may be updated at different frequencies. Thus, one alternative could be to update the department nodes at a given rate, facility nodes at a slower rate, and organization nodes at an even slower rate. Such a scheme is attractive because it does not slow down the system by causing excessive communication between the nodes. In addition, as the nodes closer to the root represent higher levels within the organization they are usually less interested in immediate real time information. The higher nodes in the hierarchy tend to be more interested in a broader picture than in the most recent information. The actual rate of updating can be set so as to ensure the network is not taxed too heavily and also so that the desired level of accuracy is met.

In other embodiments, the higher nodes may be configured to only store a sub-set of the data set available at child nodes. For example, a child node may maintain temperature readings at 5 min intervals for 8 hours but may only transfer an average temperature to the parent node. The child node may also be configured to only send anomalous or aberrant data to a parent node.

In addition, according to one embodiment, the system 10 and data structure 400 are self-scaling. This follows from at least two characteristics of the system 10 and the data structure 400. First, the processing power is decentralized. MMDs 20, that is, the leaf nodes, generally perform all the data processing for the operational data. Second, there is generally a one to one correspondence between the number of MMDs 20 and the number of machines 15 being monitored. Thus, as the number of machines 15 increases so does the number of MMDs 20 and along with them the amount of processing power available. Since each MMD 20 is responsible for performing the data collection and processing with respect to the machine 15 it is monitoring, a particular higher node requires virtually the same amount of processing power regardless of how many MMDs 20 are directly connected to it. Therefore, as the system 10 and data structure 400 grows, except for the increase in the amount of data to be stored, a limited amount of additional processing strain is put on the higher nodes of the data structure 400.

### Management Software

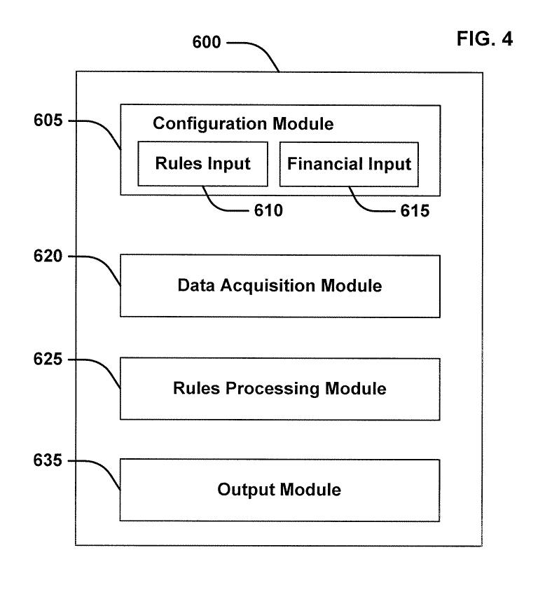

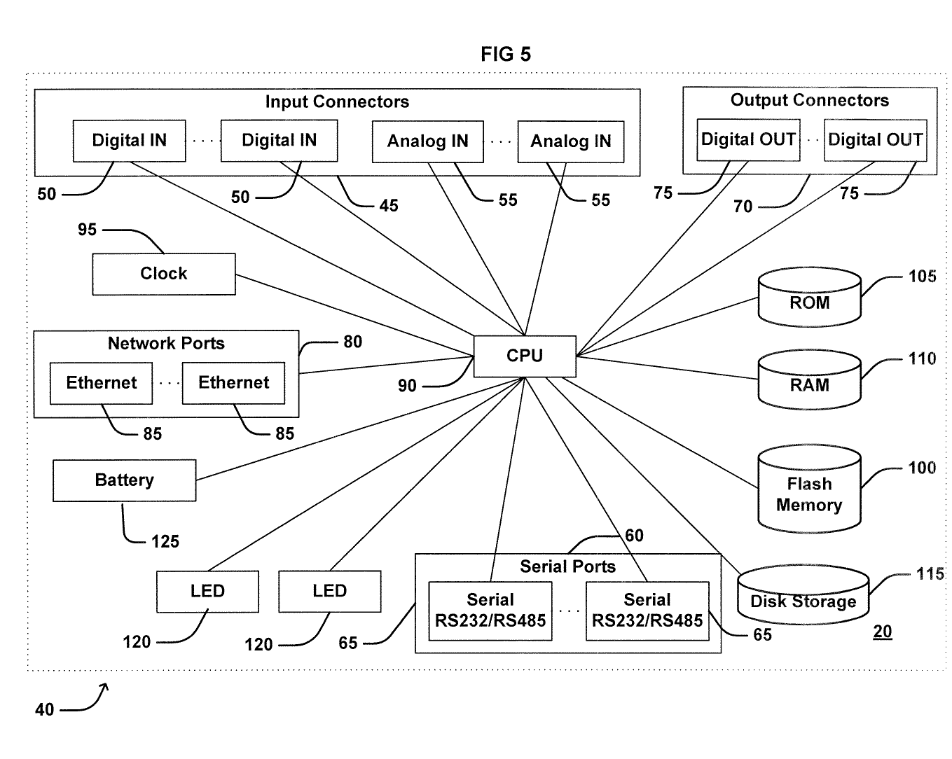

The system 10 and the data structure 400 facilitate the operation of management software 600 as a part of the system 10. The management software 600 manages the operation of the system 10, including the input, acquisition, processing and output of data by the MMDs 20, CDs 35 and servers 37. FIG. 4 shows a modular representation of an embodiment of the management software 600. The management software 600 includes a configuration module 605, which further includes a rules input module 610 and a financial data input module 615, a data acquisition module 620, a rules processing module 625 (which acts as a data processing module), and an output module 635.

In different embodiments, the management software 600 may reside on an MMD 20, a UD 35 or on a server 37 (for example, a role-based server). In other embodiments, the management software 600 may reside on some combination of the MMDs 20, UDs 35 and servers 37. For example, a part of the management software 600 may reside on the MMD 20 while another part may reside on the UD 35. In this case, the part on the MMD 20 may perform various functions and then push aggregate or time-sensitive information, such as warnings and urgent instructions or the like, to the UD 35 for immediate processing or storage, while detailed or non-time sensitive information can be requested only if needed by the UD 35 from the MMDs 20.

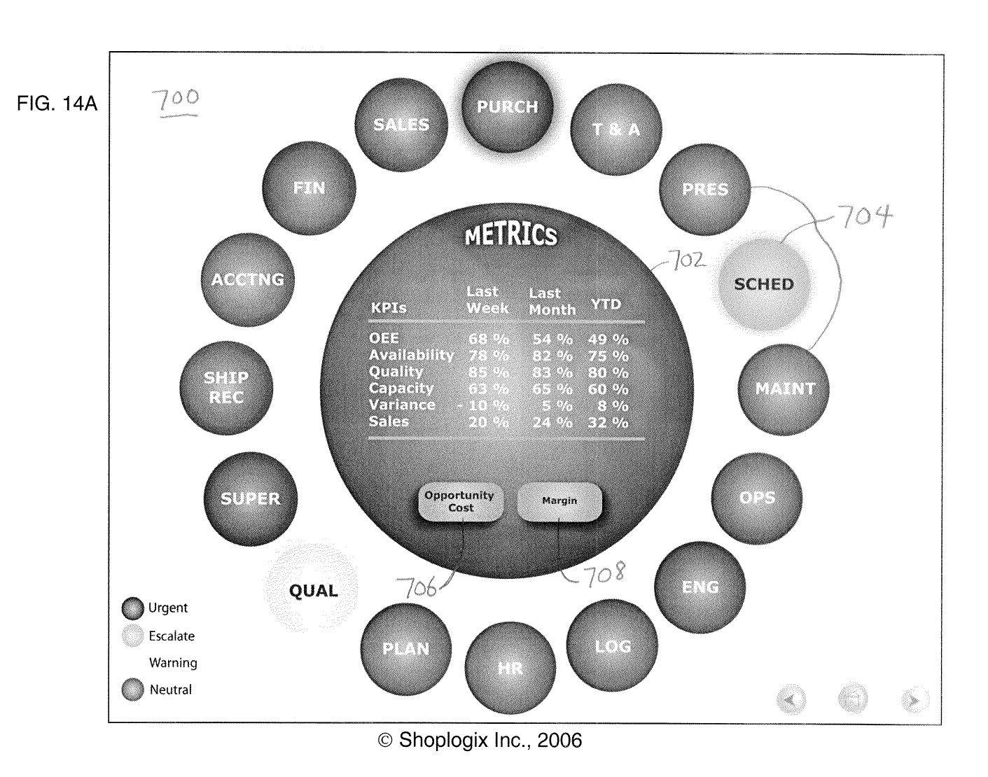

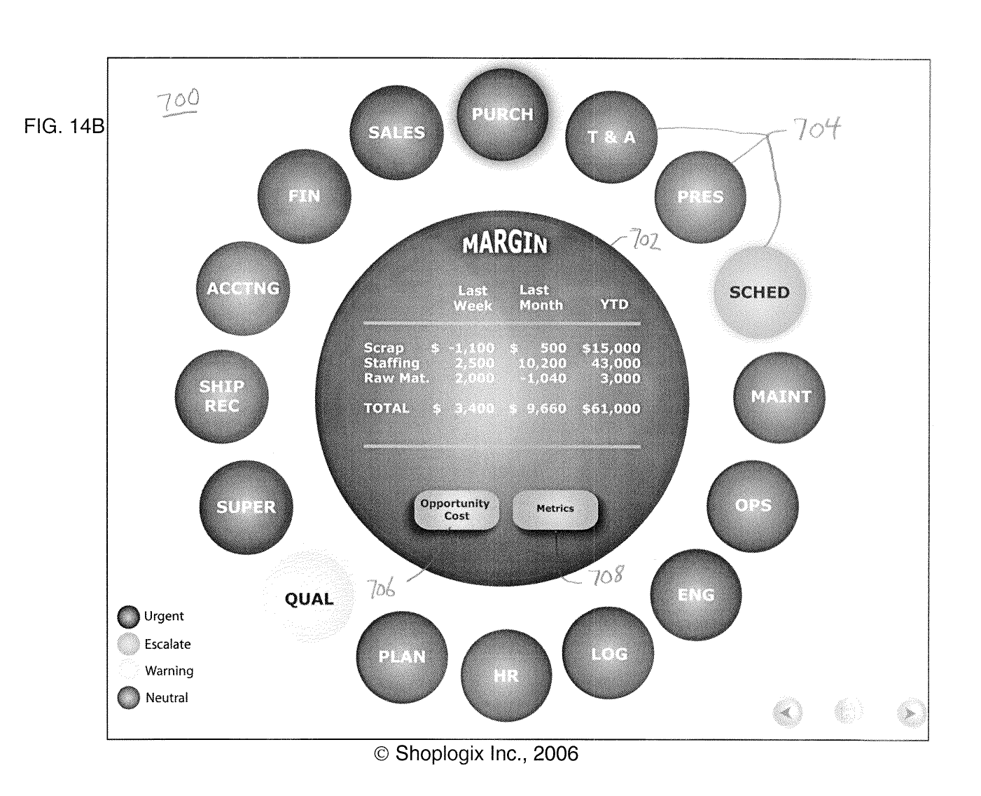

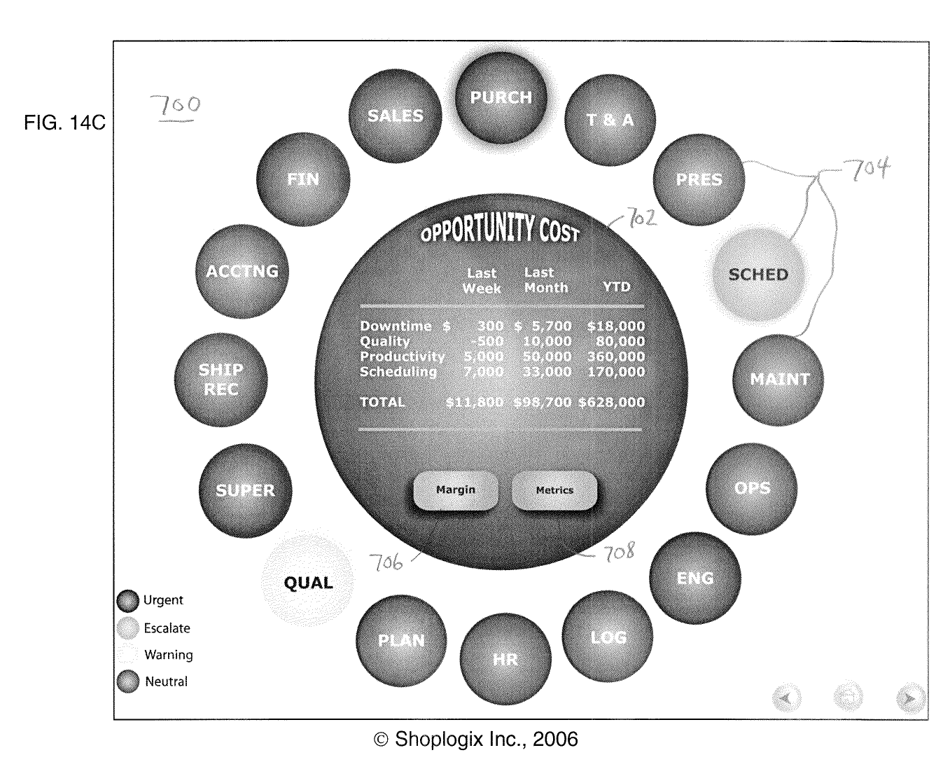

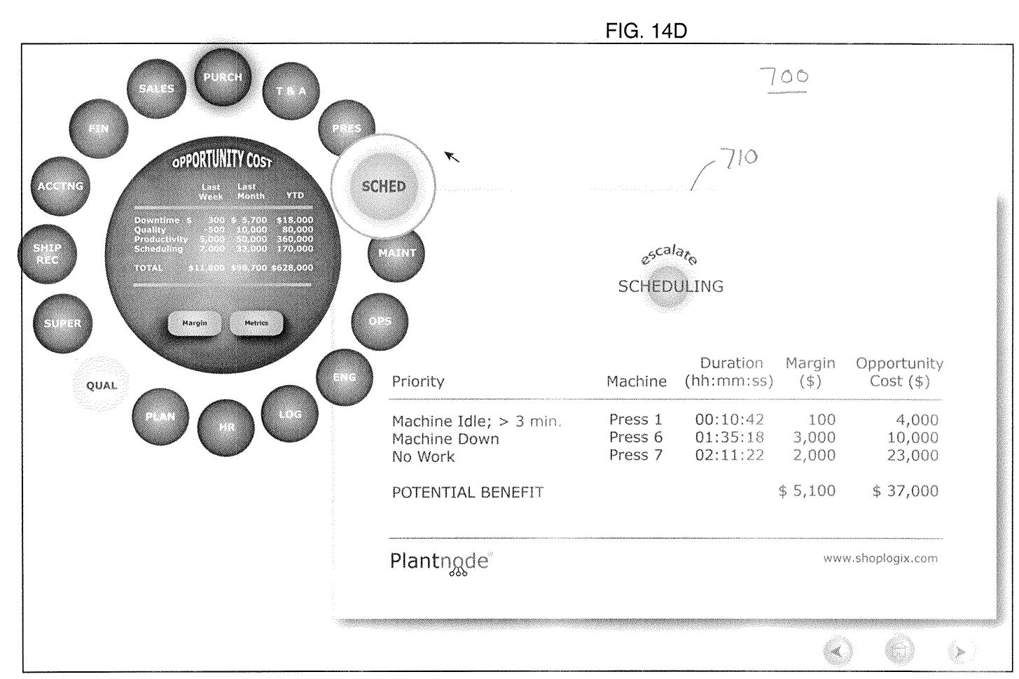

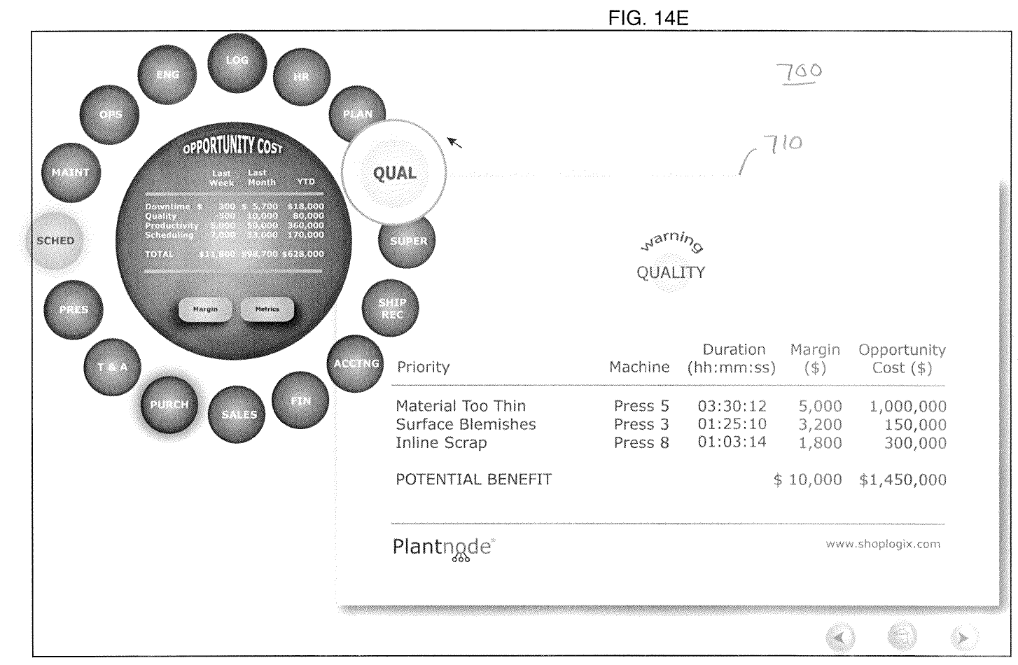

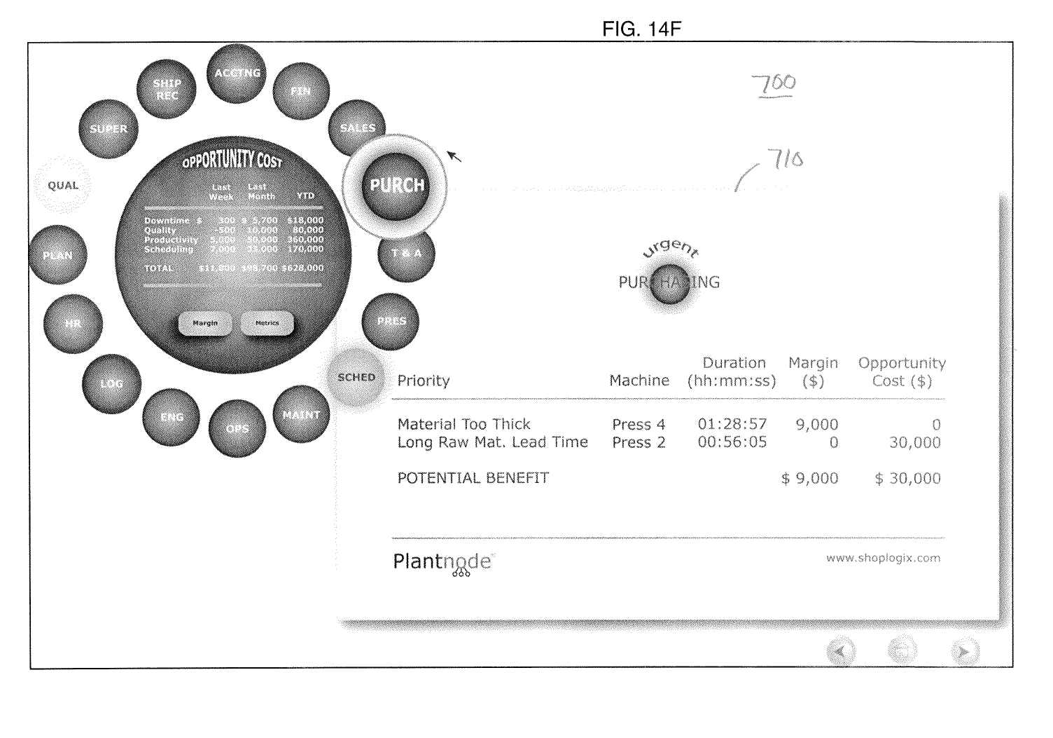

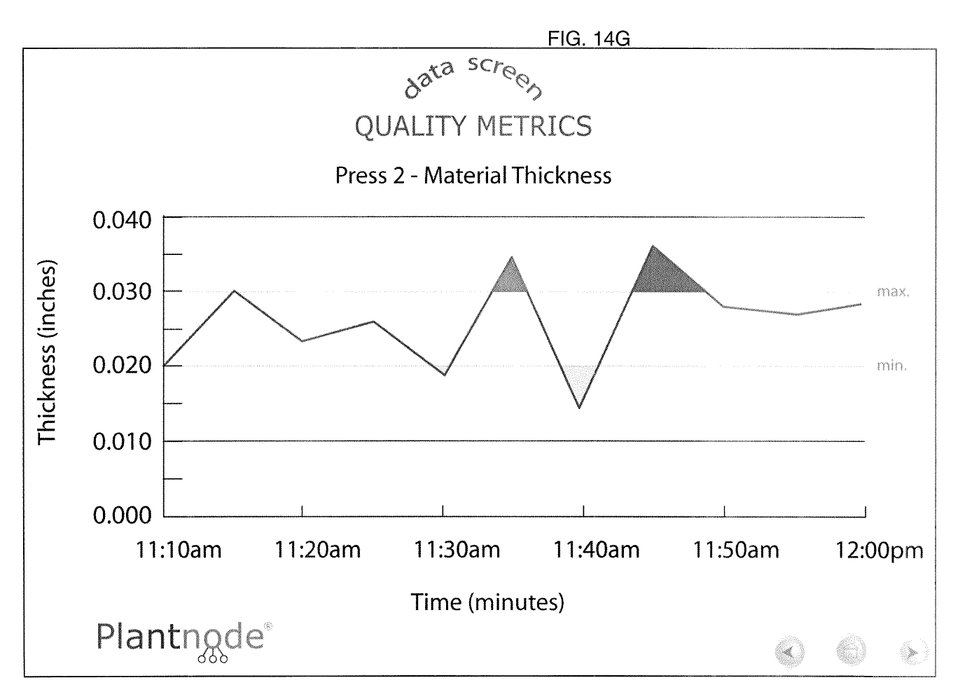

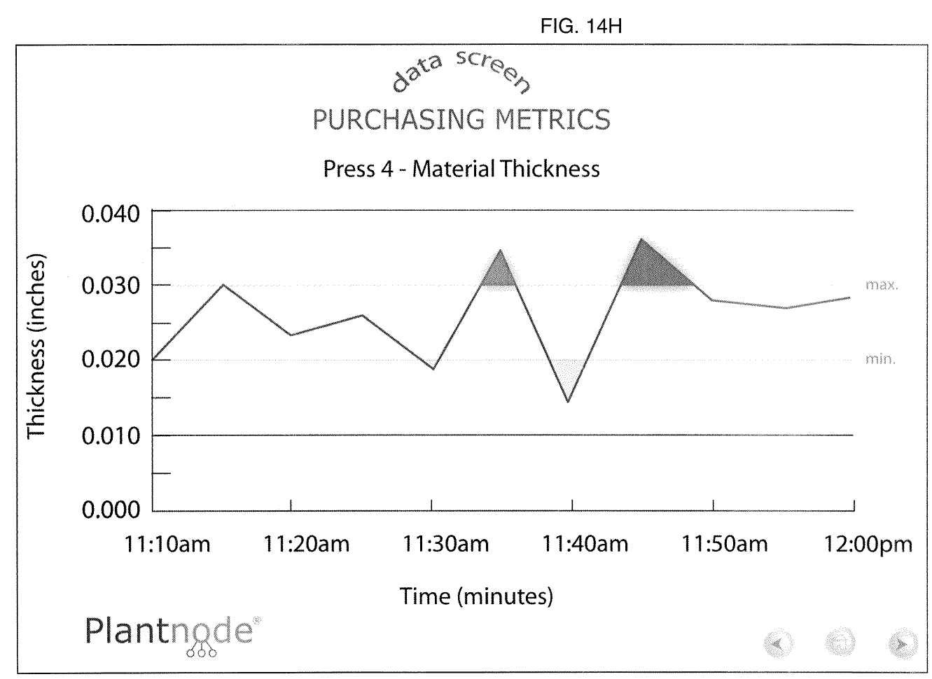

As a part of the output module 635, the management software 600 provides user interfaces for each of the modules that allow a user to configure the system, view data and reports, and the like. For example, one user interface may include a hierarchical organization view, such as that shown in FIG. 2, while another user interface may include a role-based view, as described further below with respect to FIGS. 14A-14H.

As an example of the hierarchical view, a CD 39 may, upon user request, generate a display, such as a web page, as a user interface viewable on the CD 39 that contains a list, for example, a hierarchal tree, such as that in FIG. 2, showing all the nodes, including MMDs 20, within a frame on the web page. The user may then select the MMD 20 attached to the particular machine 15 that the user wishes to view from the list, which causes the selected MMD 20 to generate a web page to allow the user to view/select reports available on that MMD 20 (either in the same frame or in another frame on the web page designated for report viewing). In the case where a department, facility node or the like is selected, the CD 39 can be configured to generate a web page showing reports at the department or facility level, which compile data from multiple MMDs 20. Further, as explained above, each CD 39 can monitor the running status of any other CDs 39 on the network. As such, any CD 39 can provide a web page user interface that facilitates access to reports on any CD 39 connected to the network 25.

In the discussion herein, the user interfaces are often described as being comprised of web pages in World Wide Web format. In this embodiment, configuration information, report requests and the like are entered and displayed in a web browser, for example, on a UD 35. The web pages could be presented in the format of a company portal. These web page user interfaces may use Hypertext Markup Language (HTML) to control the overall layout of the user interfaces, Extensible Markup Language (XML) to define the data structures used for inputs and outputs to the user interfaces, and JAVA, FLASH, ACTIVE X or other programming applets to display any requested reports in graphical format. Reports may also be automatically output, without user viewing in a format such as comma-separated values (CSV) or in Microsoft Excel™ format for archiving purposes or use by other applications.

It will be understood that the user interfaces, report formats, and language tools used to generate the user interfaces for the present embodiment are exemplary. The user interfaces used and generated for entering configuration and report requests and for presenting reports to the user may be of any type that may be readily displayed by the CD 39. It is not the intent of the applicant to restrict the use of the present embodiments to a given reporting format, user interface mechanism, or language for developing and displaying reports or user interfaces. Thus, it is not the intent of the applicant to limit user interfaces to interfaces in the form of World Wide Web pages or to limit the type of server to a World Wide Web server that generates such interfaces in the form of World Wide Web pages.

Having described the general system 10, data structure 400 and management software 600. The next section describes one embodiment of the MMD 20 in more detail, including parts of the management software 600 found on the MMD 20, including the configuration module 605, data acquisition module 620, rules processing module 625, and output module 635.

### MMD

Referring now to FIG. 5, a block diagram of the hardware components of the MMD 20 is shown generally as 40. The MMD 20 contains a variety of connectors and ports for inputs from, and outputs to, a machine 15 or to other input sensors and output devices. Input connectors 45 may include digital input connectors 50, i.e. inputs in digital format. Similarly, the MMD 20 may possess one or more analog input connectors 55 which allow the MMD 20 to receive analog inputs, i.e. inputs in the form of analog signals. The MMD 20 may also include one or more serial ports 60, such as RS232, RS485 (COM) or USB ports 65 or the like, for serial communications, including serial input and serial output, with devices capable of using such serial ports 60. These serial ports 60 are also used for handling serial protocol communications. This may include, for example, communication from manual input devices such as handheld terminals and barcode scanners as well as outputs to Light Emitting Diode (LED) display boards or the like. The MMD 20 may also contain one or more output connectors 70, such as a digital output connector 75, for sending MMD 20 output signals instructions to a connected machine 15 or other connected device. Finally, one or more network ports 80, such as an Ethernet port 85 or the like, on the MMD 20 provide network communications to CDs 39 or machines 15 capable of using network protocols. Machines 15 capable of using network protocols, such as Ethernet or the like, may be indirectly connected to the MMD 20 by communicating with the MMD 20 over the network 25.

The MMD 20 also contains a number of elements that allow the MMD 20 to act as a computing device. Instructions and operations for MMD 20 are controlled by a Central Processing Unit (CPU) 90. Synchronization of activities and instructions are carried out by reference to a real time clock 95. MMD 20 and machine 15 data is stored in flash memory 100, read-only-memory (ROM) 105, random-access-memory (RAM) 110, on an internal disk 115, or other storage media, not shown, internal to the MMD 20. The MMD 20 may also have one or more LEDs 120 for indicating MMD 20 power status and the status of various MMD 20 input connectors 45, output connectors 70, serial ports 60 and network ports 80.

In one embodiment, the MMD 20 includes a plurality of digital input connectors 50, a plurality of analog input connectors 55, a plurality of serial ports 65, which may include a software selectable serial RS232/RS485 port 65, and a plurality of digital output connectors 75. Configuration information is stored in the read/write flash memory 100, which allows for preservation of configuration information in the event of a power failure. A long-life battery 125 functions as a power back-up mechanism and ensures that the MMD 20 can continue functioning in the event of such a failure. The MMD 20 reads and stores other useful data via ROM 105 and RAM 110, or disk storage 115. Should connections to the network 25 cease functioning, this data can be forwarded on to other CDs 39 when network 25 connections are re-established. Thus, the MMD 20 may retain its configuration information and continue temporarily to monitor the machine 15 and other MMDs 20, without data loss, even in the event of a power failure. The MMD 20 also includes a plurality of MMD LEDs 120 for indicating the status of the input voltage, digital input connectors 50, digital output connectors 75, serial port(s) 65, and network connectivity via the Ethernet port 85. The Ethernet port 85 may also be used to communicate with machines 15 capable of Ethernet communications. Machines 15 that are capable of Ethernet communications will often not be directly attached to the MMD 20, rather, they will communicate with the MMD 20 over the network 25. As one skilled in the art will recognize, however, other combinations for use of memory, battery 125 backup capability, input connectors 45, output connectors 70, serial ports 60, network ports 80, and use of LEDs 120 are possible.

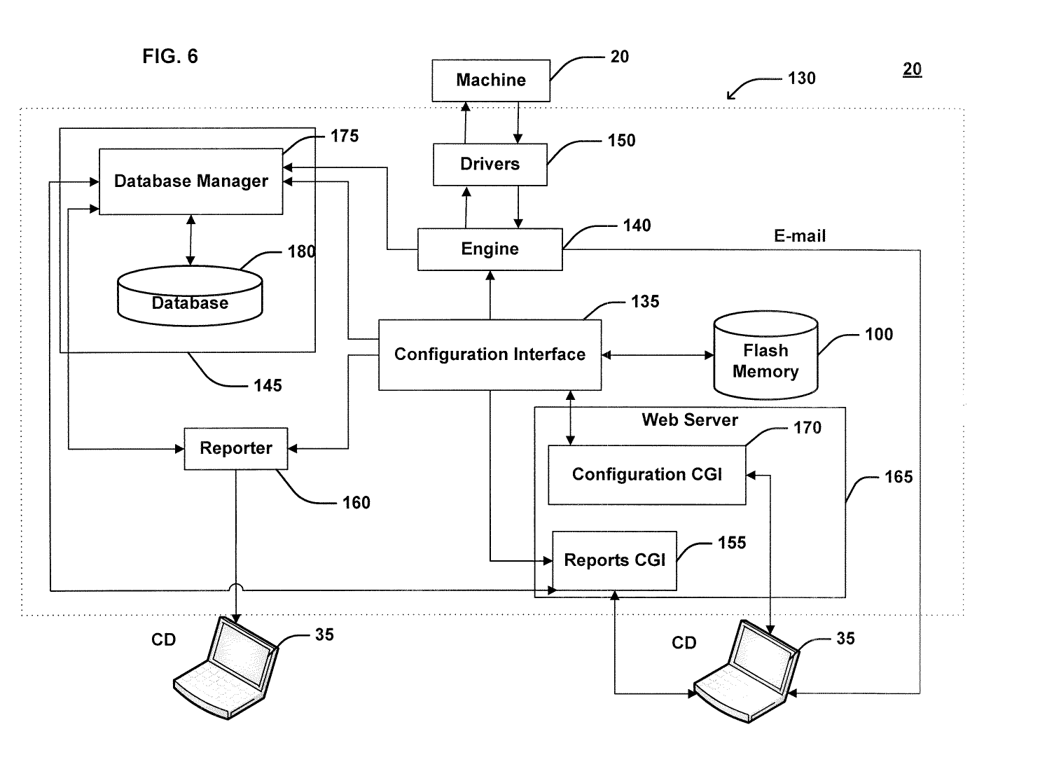

Reference is now made to FIG. 6, a logical flow diagram of some of the software and data modules of the MMD 20, shown generally as 130. To aid the reader in understanding the logical flow of the modules of MMD 20, the following description will also be referring to elements of FIG. 5. It will be understood that the software and data modules of the MMD 20 relate to software modules of the management software 600 shown in FIG. 4, as being the part/component of those modules running at the MMD level.

In brief, the software modules are comprised of the following: a configuration interface module 135 (generally related to configuration module 605 of the management software 600) for managing configuration information, an engine 140 (generally related to rules processing module 625) for performing transformations on machine inputs and generating outputs based on the machine inputs, a database system 145 for storing report data, drivers 150 (generally related to data acquistion module 620) for translating machine inputs to a format useable by the engine and engine outputs for use by machines, a reports CGI module 155 and reporter module 160 (both generally related to output module 635) which generate reports, and a web server 165 (generally related to output module 635) or the like for generating user interfaces for requesting and viewing reports and for entering and viewing configuration information, as well as handling input from the user interfaces. The reports CGI module 155 is a component of the web server 165 and handles user requests for reports and outputs the reports in the form of web page user interfaces. The web server 165 further comprises a configuration CGI module 170, which handles generation of web page user interfaces for entering and viewing configuration information. The database system 145 further comprises a database manager 175 and a database 180. The database manager 175 reads and writes data to the database 180, which stores the actual information required for report generation. These modules are explained in greater detail below.

The configuration interface module 135 stores and manages the MMD configuration information, which may be stored in flash memory 100. The configuration information is typically determined as a function of the reports that are to be generated and includes variable names for inputs from machines and outputs required for reports, transformations to be performed by the engine, structure of the database 180 within the database system 145, report formats, and queries.

The configuration interface module 135 is preferably the only module that can read or write to the flash memory 100 that contains the configuration information. Thus, the configuration interface module 135 is used for reading and writing of configuration information for the MMD 20 to the flash memory 100 during the initial MMD 20 configuration and after configuration changes. As such, the configuration interface module 135 interacts with the configuration CGI module 170, which generates the web page interface through which the user enters and views configuration information on the UD 35. The configuration CGI module 170 transmits configuration information entered by the user to the configuration interface module 135, which then writes this information to the flash memory 100. In addition, the configuration interface module 135 also supplies all necessary configuration information, by reading from the flash memory 100, to all other modules after configuration changes or during MMD 20 initialization. The other modules receive this information during initialization and store it in memory for subsequent use. Thus, once the other modules have been initialized with the configuration information, the configuration interface module 135 does not need to provide this information again unless there is a change in configuration or system re-start, such as after a power failure, etc. By using the configuration interface module 135 as an intermediary between all other modules and the configuration information stored in the flash memory 100, the MMD 20 ensures that each module is furnished with the configuration information required for the module's tasks and that only one module accesses the configuration information in the flash memory 100 at any given moment.

The configuration interface module 135 also maintains, as part of the configuration information, user names and passwords. Users may thus use these passwords, from web page user interfaces, to view and modify system configuration information as required for the daily use of the system. Different levels of access and modification permissions are accorded to users based on their classification as belonging to a group having certain access and modification rights. For example, there could be three groups of users, such as basic users, administrators, and integrators, with basic users having the least rights, administrators having additional rights, and integrators having the most rights. In this manner, the ability to effect necessary modifications to the configuration information is ensured while maintaining security.

The engine 140 monitors machine inputs via the drivers 150. More specifically, the drivers 150 receive the inputs from the digital input connectors 50, analog input connectors 55, and serial RS232/RS285 ports 65 and translate them into a format useable by the engine 140. For each input, there is a variable associated with the input's value. This incoming data is generally referred to as operational data because it is data relating to operation of the machines 15 in a manufacturing facility. However, it will be understood that the operational data may include any type of data that may be generated in the operation of an organization.

Operational data is generally gathered, and stored locally by each MMD 20. The type of data of interest may vary depending on the particular MMD 20 and the machine 15 it is monitoring. Moreover, not all data that is gathered needs to be stored. Thus, for each MMD 20, the data that is gathered, and stored, may vary. In some cases, the incoming data may simply be processed and/or displayed and not stored. For other data, an average value over a given time period may be stored. Further, some data may only be monitored to detect a change or variance from a previous value or an anticipated/estimated value or a change or variance that is over a predetermined threshold. The manner in which data is gathered, processed and stored is generally set during the configuration process. For example, consider an MMD 20 monitoring, among other things, the temperature of a machine 15. The MMD 20 may display the instantaneous temperature on a display located near the machine 15. This data may be important for the person operating the machine 15. However, although the MMD 20 gathers and displays the instantaneous temperature, if everything proceeds normally, the MMD 20 may not need to store more than the average, minimum and maximum temperature over a given time period. The actual data stored by the MMD 20 may vary depending on its instructions and the conditions present at the time. Thus, in the same example, if the temperature were to move outside of predetermined acceptable limits, then the MMD 20 may store additional data, perhaps comprising such things as more frequent temperature samples and the time at which the temperature moved in and out of the predefined limits. These limits can be configured as rules for the MMD 20 to follow and may include a rule that a person in a particular role in the organization is to be notified in particular circumstances.

In an exemplary case, the engine 140 compares the last value received for each input, as contained in the variable associated with the input, with the current value of the input. If an input change is detected, the engine 140 applies transformations to the input value for which an input change has been detected. These transformations may include basic mathematical transformations such as multiplication or division, Boolean logic, comparison with other values, and transformation for measuring and comparing inputs or variables over a given period of time. An example of possible transformations is shown in Table 1.

TABLE 1

| | # of | |
|---|---|---|
| Operation | inputs | Result Variable Value |
| Copy | 1 | copy of the input variable |
| Invert | 1 | Boolean inverse of the input variable |
| Bitwise Invert | 1 | bitwise invert of the input variable |
| Absolute Value | 1 | absolute value of the input variable |
| Plus + | 2 | Input1 + Input2 |
| Minus − | 2 | Input1 − Input2 |
| Multiplied By * | 2 | Input1 * Input2 |
| Divided By / | 2 | Input1 / Input2 |
| Less Than < | 2 | TRUE if Input1 < Input2 otherwise |
| | | FALSE |
| Greater Than > | 2 | TRUE if Input1 > Input2 otherwise |
| | | FALSE |
| Less Than or | 2 | TRUE if Input1 <= Input2 otherwise |
| Equal To <= | | FALSE |
| Greater Than or | 2 | TRUE if Input1 >= Input2 otherwise |
| Equal To >= | | FALSE |
| Is Equal To == | 2 | TRUE if Input1 equals Input2 otherwise |
| | | FALSE |
| Is Not Equal To != | 2 | TRUE if Input1 is not equal to Input2 |
| | | otherwise FALSE |
| And | 2 | TRUE if Input1 is TRUE and Input2 is |
| | | TRUE otherwise FALSE |
| Or | 2 | TRUE if Input1 is TRUE or Input2 is |
| | | TRUE or both are TRUE otherwise |
| | | FALSE |
| Exclusive Or | 2 | TRUE if only Input1 is TRUE or only |
| | | Input2 is TRUE otherwise FALSE |
| Round | 2 | Rounds Input1 to accuracy specified by |
| | | Input2 |
| Value Sampling | 2 | Copies Input1 but only at fixed time |
| | | intervals which are specified by Input2 |
| Deadband | 2 | Copies Input1 but only if its value has |
| | | changed by the amount specified by |
| | | Input2 |
| Timer (seconds) | 1 | # of seconds that Input1 has been TRUE |
| | | for |
| Counter | 1 | # of times that Input1 has been TRUE |
| Limit Output Range | 3 | Copies Input1 but only if its value is |
| | | within the specified Lower Limit and |
| | | Upper Limit |
| Max Over Time | 2 | maximum value that Input1 has had over |
| | | the time period specified by Input2 |
| Min Over Time | 2 | minimum value that Input1 has had over |
| | | the time period specified by Input2 |
| Spread Over Time | 2 | maximum value that Input1 has had over |
| | | the time period specified by Input2 |
| Count Over Time | 2 | # of times that Input1 has been TRUE |
| | | over the time period specified by Input2 |
| Average Cycle Time | 2 | ratio of seconds to # of times that Input1 |
| | | has been TRUE over the time period |
| | | specified by Input2 |

The result of each transformation is another variable designated to hold the value of the result of the transformation. As such, an input change may undergo a number of transformations, using a number of intermediate variables, until the result required for inclusion as a field in a report or for display as a graph in a report, referred to as a report variable, is calculated. Variables required for such displays are referred to as report variables. When the engine 140 is finished processing the input change, it forwards the results, i.e. any resulting report variables, to the database manager 175. Typically, only changes in the value of report variables, referred to as report variable changes, are transmitted by the engine 140 to the database manager 175 for storage in the database 180.

In this example, by limiting any transformations on inputs with a view to transmission to the database manager 175 to those cases where an input change is detected, as opposed to using more traditional methods of processing and storing all inputs on a constant basis, the engine 140 consumes fewer resources. The fact that only report variable changes are sent by the engine to the database manager 175 and recorded in the database 180 further minimizes storage requirements and processing resources required. However, since the engine 140 is constantly monitoring all inputs received from the machine 15, input changes are detected and variable changes are calculated and stored almost instantly, thus ensuring precision of the MMD 20 reports is not compromised.

The engine 140, may also generate engine outputs in the form of MMD 20 output signals, data packages for other nodes and e-mail notifications in response to inputs from machines 15, whether there has been an input change or not, based on time, or in response to the result of transformations undertaken by the engine 140 in response to an input change. For example, the engine 140 could generate instructions to activate or deactivate a PLC, relay, or LED that would be sent, via the drivers 150, over a digital output connector 75. E-mail notifications or data packages may be sent with a time delay, or to one or more recipients/nodes, the identity and quantity of recipients/nodes also being dependent on the results of the handling of the input. Such e-mails and data packages would typically be sent via the Ethernet port 85.

Variable names and the exact transformations applied by the engine 140, are dependent on the reports which are to be made available and instructions for handling inputs, both of which are set out in the configuration information. This information is transmitted to the engine 140 by the configuration interface module 135 when the engine 140 is initialized or after a configuration change. The engine 140 may also use thresholds provided in the configuration information during transformation of the input change to determine whether the resulting variable is significant enough to be handled/transformed further and transmitted to the database manager 175 or to generate notifications or the like. Engine outputs, namely MMD 20 output signals, data sets and e-mail notifications performed by the engine 140, are also set by the configuration information.

The database 180 is the repository for all stored data, including report variables required for generating the reports. It receives and outputs information via the database manager 175. The database manager 175 is preferably the only module that has direct access to the database 180. All other modules that need read/write access to the database 180 use the database manager 175. In this fashion, the database manager 175 ensures that only one module can access data from the database 180 at any given time, thus ensuring that data integrity is not compromised by one module writing to the database 180 while another module is reading from it.

In particular, the database manager 175 executes queries such as Structured Query Language (SQL) queries received from the reports CGI module 155 and reporter module 160 and extracts and processes data from the database 180 as required by the queries. The database manager 175 then forwards the results of these queries, generally as collections of records, to the reports CGI module 155 and reporter module 160 which output them as required.

The contents and structure of the database 180 are dependent on the data inputs from the machine 15, the transformations and report variable changes resulting from treatment by the engine 140, and the database 180 structure. The database 180 structure is based on the report variables that are to be stored so as to be entered in fields or displayed as graphs in the desired reports as set out in the configuration information. The database manager 175 establishes the database 180 structure in accordance with this configuration information, and reads and writes records and fields of the database 180 in accordance with this structure. The configuration information is transmitted to the database manager 175 by the configuration interface module 135 upon initialization of the database manager 175 after powering up the MMD 20 or after a configuration change. For each report specified in the configuration information, there is generally a corresponding table in the database 180. Each report variable, as established in the report configuration information, constitutes a field within each record of the table assigned to that report. Each record within a table captures all of the values for the report variables required for the record as well as the time at which these variables held that value. As in the example above, new records are typically input to a table in the database 180 only when there is a change in one or more report variables required for the record. In this manner, processing resources and storage space required for the database 180 can be reduced.

For example, suppose a report indicating whether a machine 15 is running or not is set out in the report configuration information. Upon initialization, the configuration interface module 135 will transmit the names of the report variables used to capture the running status to the machine 15 for display in the report and an identifier for the report to the database manager 175. The database manager 175 will then execute an SQL command to cause a table bearing the identifier's name to be created in the database 180. Each record in the table will include a field for the value of the report variable that represents the running status of the machine 15, as well as a field for the time at which the report variable for the running status of the machine 15 acquired that value. When the value for the report variable changes, after processing by the engine 140 and submission of the new value to the database manager 175, the database manager 175 causes a new record to be created in the table which captures the new value and the time at which the change in value occurred.

Although the present embodiment makes use of a relational database, it is not the intention of the inventors to restrict the database 180 or database manager 175 to a relational format. A person skilled in the art will recognize that other formats for the database 180 and database manager 175 are possible.

The drivers 150 are responsible for handling inputs from and outputs to machines 15 connected to the MMD via the digital input connectors 50, analog input connectors 55, digital output connectors 75, Ethernet port 85, and serial RS232/RS485 ports 65. As such, the drivers 150 can handle digital inputs, analog inputs, and serial communications and provide such inputs in a format useful to the engine 140. In turn, the engine 140 uses drivers 150 to forward the engine 140 outputs that the engine 140 generates to the appropriate output connectors 70, RS232/RS485 serial ports 65, or Ethernet port 85. For example, MMD 20 digital output signals could be transmitted to a machine 15 connected to a digital output connector 75 via drivers 150.

In this embodiment, the web server 165 generates user interfaces and handles input and output to them. The interfaces are displayed as web pages in a web browser on a CD 39, from which the user enters information into the web page and views results. More specifically, the web server 165 generates web page user interfaces for requesting reports and entering report parameters. This functionality is provided by the reports CGI module 155, which, in this example, is comprised within the web server 165. In addition, the web server 165 also provides generation of web page user interfaces for entering and viewing the configuration information via the configuration CGI module 170, here also comprised within the web server 165. It should be noted that the configuration CGI module 170 and reports CGI module 155 do not necessarily have to be implemented within the web server 165 and could instead be implemented as external modules to the web server 165, yet resident on the MMD 20, that would provide data from which the web server 165 would generate and transmit the required web page user interfaces. It is not the intention to restrict the exact placement within the MMD 20 of the reports CGI module 155 or configuration CGI module 170 with regard to the web server 165.

The reports CGI module 155 generates reports based on user requests. The reports CGI module 155 provides a user friendly, web page interface for generating MMD 20 reports on the connected machine's 15 operational data. When a user requests to view the reports available for a machine 15, the reports CGI module 155 generates a web page containing a menu of reports to view. The user may then select a report and enter the desired report parameters into the web page interface provided by the reports CGI module 155 to the CD 39 for the report selected. The parameters typically involve time intervals, referred to as shifts, for monitoring the machine 15 between a scheduled start and end time for workers or machines 15. The reports CGI module 155 then uses the parameters input by the user to generate an SQL query, which is sent to the database manager 175. The database manager 175 executes the query to obtain the desired information from the database 180 and transmits the results to the reports CGI module 155. The reports CGI module 155 uses this information to generate a web page containing the selected report, which is transmitted to the user's CD 39. The contents and structure of the reports, which determine the SQL queries, are initially provided to the reports CGI module 155 by the configuration interface module 135, either during initialization or after changes to the configuration.

The reports CGI module 155 is capable of modifying reports in real-time in response to changes in inputs, as handled by the engine 140 and database manager 175 and set out during configuration, to allow a user to see changes as they occur. Using templates that set out each basic type of report, the reports CGI module 155 generates, for example, HTML files to control the appearance of the web pages, Java or Flash applets to generate graphs, and XML files to contain and describe data structures used by the reports. Further detail regarding reports is provided below.

The reporter module 160 also generates reports. However, reports generated by the reporter module 160 are generally not requested and displayed via user interfaces generated by the reports CGI module 155 of the web server 165. Rather, if so configured, the reporter module 160 automatically generates and stores backups of MMD 20 reports (that is, data sets or sub-sets thereof) to a CD 35 on the network 25 at pre-determined time intervals. The time intervals, contents of the reports, and format of the reports are output to the reporter module 160 by the configuration interface module 135 during initialization. The reporter module 160 uses this information to generate an SQL query at, for example, pre-configured time intervals and transmits the query to the database manager 175. The database manager 175 executes the query to obtain the desired information from the database 180 and transmits the results to the reporter module 160. The reporter module 160 then uses this information to generate a report (data set), which it transmits to the designated CD 39 on the network 25. The report may be output in a format readable by CD 39 and/or by a database on CD 39, including formats such as XML, Microsoft Excel™ or CSV format. Reports can be stored on the designated CD 39 in a database or alternatively as a single continuous file for all reports or as a separate file for each period of time, which may represent a work shift within the production environment, as defined in the configuration information.

The configuration CGI module 170 provides an easy to use, user-friendly web page user interface for configuring all of the MMD 20 settings, including variables, rules and the like. In this embodiment, it is comprised within the web server 165. More specifically, the configuration CGI module 170 generates HTML web pages into which configuration information may be entered or viewed. These web pages are created based on templates that contain the basic web page structure for each type of configuration information to be entered or displayed. Using the templates, the configuration CGI module 170 generates HTML files to control the overall appearance of the configuration web pages while storing data structure information required for the web pages in XML files. The user enters configuration information in the web page interface transmitted to, for example, the UD 35, via the configuration CGI module 170. In addition, the configuration CGI module 170 also allows a user to upload or download existing configurations to/from a networked MMD 20, UD 35 or server 37. Once the configuration information is entered, the configuration CGI module 170 reads/writes the information to the configuration interface module 135, which in turn reads/writes the data to the flash memory 100.

Although the above description describes use of HTML, XML, and JAVA™ to define web page interfaces and/or reports, it is not the intention of the inventors to restrict such interfaces and/or reports to a web base format or to use a particular language to generate the web pages. A person skilled in the art will recognize that other formats for the reports are possible and that other languages or tools, such as Flash™, Microsoft™.NET™, and the like may be used to generate the reports or interfaces.

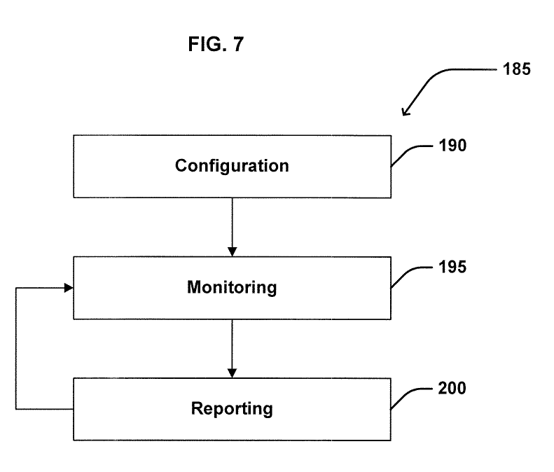

FIG. 7 is flowchart of a general method 185 of setting up and operating an MMD 20 according to one embodiment. It will be understood that this process is similar to the configuration and operation of the other elements of the overall system 10 and the management software 600.

Beginning at the configuration step 190, the MMD 20 is configured by the user. This includes connecting the machine 15 to the MMD 20 and configuring reports, variables, rules network ports 80 and connections, serial communications via serial ports 60, machine 15 inputs via input connectors 45 and MMD 20 output signals via output connectors 70. At the end of this step 190, required configuration information is transmitted to the software modules. The MMD 20 software modules are then initialized with the configuration information. Next, at the data acquisition or monitoring step 195, the MMD 20 monitors the machine 15. During this monitoring step 195, the engine 140 monitors and transforms the machine's 15 inputs, provides engine 140 outputs as configured, and sends necessary information as report variable changes to the database system 145. Next, at the reporting step 200, the MMD 20 generates reports as requested by the user and transmits them to the user via a user interface generated by the web server 165 and displayed on the user's UD 35. The MMD 20 also generates reports automatically, via the reporter module 160, at given intervals and formats, as configured, and sends the reports to a UD 35 via the network 25 for archiving or processing by other applications. It should be noted that the monitoring step 195 is ongoing and is constantly repeated, even while reports are being generated automatically and requested by the user during the reporting step 200. Thus the monitoring step 195 and reporting step 200 constitute an ongoing cycle that continues until the MMD 20 is disabled, not shown, or there is a change in MMD 20 configuration, not shown.

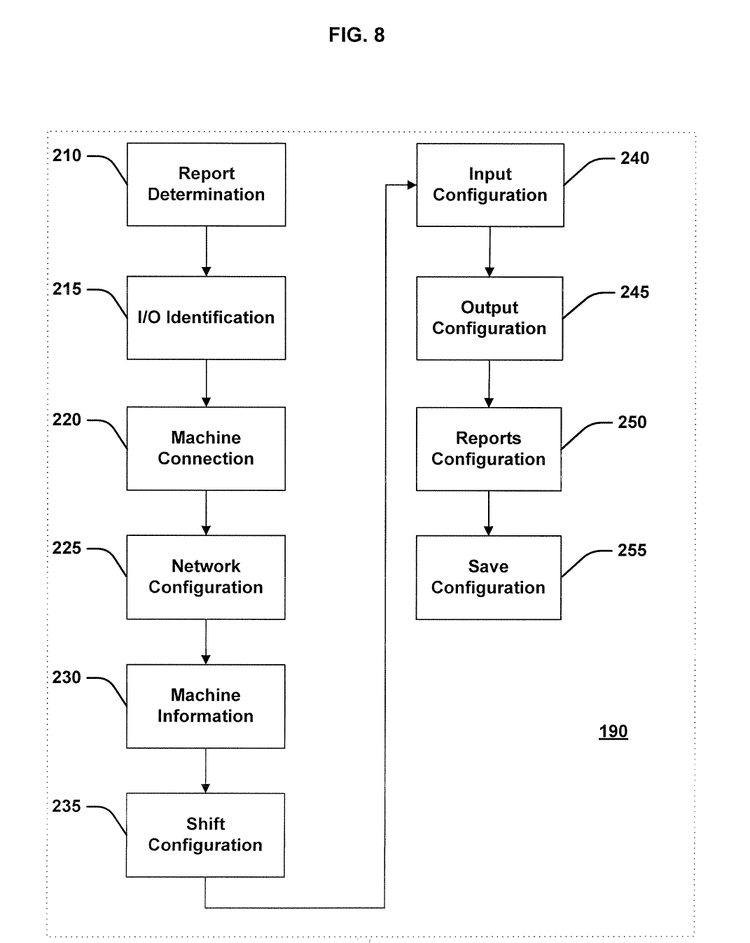

Reference is now made to FIG. 8, a flowchart of the MMD configuration step 190 of FIG. 7. Beginning with the report determination step 210, the user determines what type of reports the user desires and the operational data required for such reports. Examples of reports or elements of reports include: machine status data, signal data, maintenance data, product count data, alarm data, and others.

Machine status data provides information about the time the machine 15 is in a given state. For example, the report might show the relative times that the machine 15 has been running, cutting, undergoing maintenance, idle, off, etc. Machine status reports can be cumulative or chronological. A cumulative machine status report may provide a pie chart that shows the proportions of the time interval during which the machine 10 was in each state. For a chronological machine status report, a bar chart may be used to illustrate which states the machine 15 was in at each moment over a given interval of time. Machine status reports require that the user determine which states the user would like to monitor. The system 10 may include preset defaults for typical requirements.

Signal reports plot data from a particular sensor/signal over time, such as temperature, vibration, spindle load, cabinet humidity, or the like. These reports thus allow users to see trends in the signal but also what is occurring in real time. The user can define limits which can be displayed on the chart and the user can choose to have the engine 140 generate alarms and/or send e-mails as the limits are approached or surpassed. This report requires that the user determine the information to be monitored, applicable limits, and actions to be taken as limits are approached or surpassed.

Maintenance reports determine whether fault data is available from the machine 15 (for example, via the RS232/RS485 serial ports 65) and to track fault information. Faults can be recorded with a start and end time along with their duration. The maintenance reports can be cumulative, which display bar charts for the length of each fault. The reports can also be chronological maintenance reports, which show the status of each fault type over a given period of time. Finally, maintenance reports may also be preventative maintenance meter type reports. These reports allow a user to work with an input like a car does with its odometer. The user can reset the meter at any time and let it keep track of the input for a predefined time interval. Maintenance reports require that a user identify the type of fault to be monitored as well as the desired time intervals.

A product count report displays a bar chart that shows production count, such as number of units produced by a machine 15, over the course of a shift or number of shifts. Usually a digital signal is used to determine a completed cycle and a factor is used by the engine 104 to determine how many parts were produced from that cycle. However, when further input data is available, for example using a serial RS232/RS485 port 65, a user can gather batch and part numbers to reference identification information with the part count data. The user identifies the desired information and time intervals for this report.

Alarm data can be based on any signal, real or derived. Alarms are typically entered as a rule, such as “if temperature exceeds X, sound alarm and notify maintenance”. Alarms can be visual or audible signals as well as emails generated by the engine 140 and sent to a CD 39 or particular user. The engine 140 can also allow for a delay so that the same alert can be escalated to multiple people within an organization. The user identifies the events for which they wish to have an e-mail notification generated, to which e-mail address the notification should be directed and what time delay should be applied before sending the e-mail or additional e-mails (time delay relative to when the alarm occurred). Multiple email notifications can be configured with different time delays and different recipients for the same alarm. Thus, an e-mail notification can be sent, as an e-mail notification escalation, to increasing numbers of people at increasing levels of authority as time goes on if the condition that has caused the e-mail notification for an alarm to be generated is not corrected. It will be understood that an e-mail notification may be replaced with a pager alarm, automated voice call, or any generally known notification procedure.

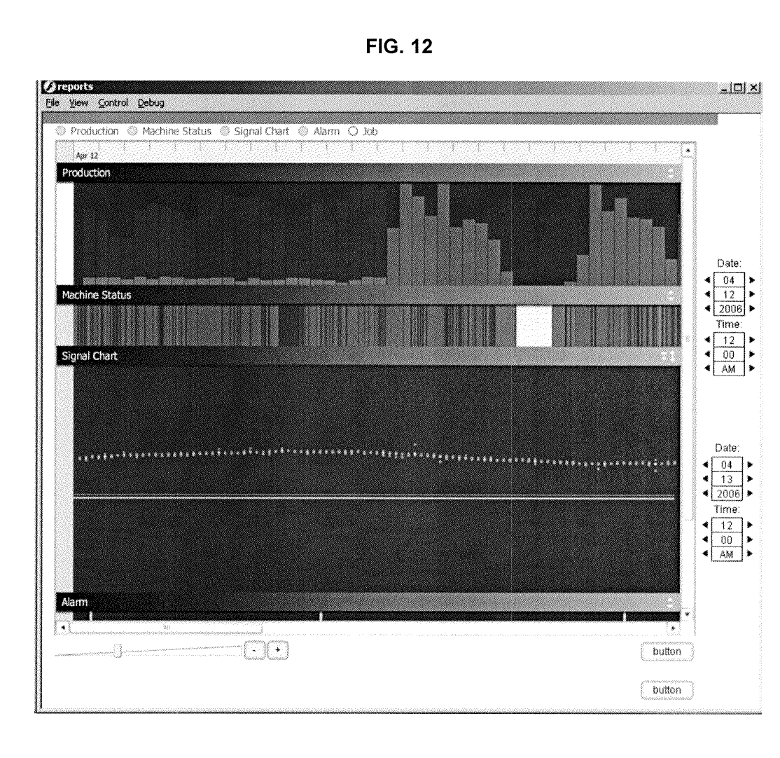

Further examples of reports and reporting are provided below with reference to FIGS. 12-14.

Next, at the input/output identification step 215, the user identifies the inputs required to capture the information required for the reports. Thus, for each report desired, the user determines which inputs and outputs are necessary to generate or provide the information required for the report and the signals required to provide such inputs and outputs. These will determine which combinations of digital input connectors 50, analog input connectors 55, digital output connectors 75, and serial RS232/RS485 ports 65 are necessary. The signals available will vary by type of machine 15. From an input perspective, a combination of digital signals may be used to derive the desired information or machine state. Analog inputs also may be combined with digital inputs to provide additional information. For example, an analog voltage input may be used to indicate when the machine 15 is cutting versus whether the machine 15 is simply running or not, as might be indicated by a digital input. As for outputs, the user will have to decide which output connectors 70 to a machine 15, or serial RS232/RS248 ports 65, or Ethernet port 85 may be used to provide the required MMD output signals.

Next, at the machine connection step 220, the user connects the appropriate outputs from the machine 15 to the corresponding digital input connectors 50, analog input connectors 55, and serial RS232/RS485 ports 65 on the MMD 20 to provide the inputs required. For example, digital outputs from the machine are connected to digital input connectors 50 on the MMD 20, analog outputs are connected to analog input connectors 55 on the MMD 20. Serial connections from the machine are connected to the serial RS232/RS485 ports 65 to provide serial inputs and outputs. As well, any additional digital, analog or serial inputs can be added to bring data into the MMD 20. Digital outputs to the machine 15 are ensured by connecting digital output connectors 75 from the MMD 20 to digital inputs on the machine 15 or machine lights such as LEDs. The user may also connect an Ethernet-enabled machine 15 to the Ethernet port 85 to provide inputs at this time. However, preferably, such an Ethernet-enabled machine will be connected to the network 25, over which the machine 15 will communicate with the MMD 20.

Moving now to the network configuration step 225, the user may connect a CD 39 directly to the MMD 20 to configure the Internet Protocol (IP) settings by which the MMD 20 will communicate with the network 25. Alternatively, the MMD 20 may have an optional keyboard/display for configuration purposes. A network configuration utility allows the user to set parameters for the IP address, the domain name server (DNS) address, the gateway address, the subnet address information, and whether Dynamic Host Configuration Protocol (DHCP) services are available. After the IP configuration information has been entered, the user may connect the MMD 20 to the network 25 via the Ethernet port 85 which will allow the user to continue configuration via a web page user interface from any UD 35 on the network 25 or from a UD 35 directly connected to the MMD 20. To do so, the user enters, for example, the IP address of the MMD 20 device from any web browser enabled UD 35. The web server 165 then generates an initial web page interface containing a menu of configuration and reports options and transmits it to the UD 35. From this web page interface, the user selects the configuration option. This causes a configuration web page user interface to be generated by the configuration CGI module 170. From the configuration web page interface, the user then selects the desired configuration items, which causes the configuration CGI module 170 to generate additional pages for entering or viewing the appropriate configuration information.

For example, if a user wishes to configure inputs, the user first selects configuration from the initial web page user interface menu, which causes the configuration CGI module 170 to generate the configuration web page user interface containing the configuration options. From this page, the user then selects the option for configuration of inputs. This causes the configuration CGI module 170 to generate another web page containing the necessary fields into which the user may enter the information necessary for configuring the input. This information is transmitted back to the configuration CGI module 170 which processes the configuration information entered and transmits it the configuration interface module 135 which, in turn, stores it in the flash memory 100 and transmits it to the appropriate modules.

Proceeding now to the machine information step 230, the user enters basic machine 15 and MMD 20 information via one or more web page user interfaces generated for this purpose by the configuration CGI module 170. This information includes, among other things: a device name to associate the MMD 20 with the machine 15 to which it is connected, system user names and corresponding passwords, whether the user desires that digital signals for alarms be inverted, IP address information if not already provided, and the IP address of a time server for providing time information. If desired, the user may also choose to import or export configuration information to/or from a file on the user's UD 35.

Moving next to the shift configuration step 235, the user defines the shifts that are used in the reports generated by the reports CGI module 155 and reporter module 160. The shifts are used to determine default time intervals for reporting purposes and refer to the period between a scheduled start and end time for workers or machines 15. Relevant shift information is eventually forwarded to the reports CGI module 155 and reporter module 160. To configure shifts, the user selects the shift configuration option from the configuration web page user interface. This causes a shift configuration web page user interface to be generated by the configuration CGI module 170. The user then enters information into the shift configuration web page user interface to assign a name to each shift, define the time intervals applicable to the shift, and assign a color to be used to represent the shift in reports that display graphical representations of machine data for the shift.

Moving now to the input configuration step 240, the user enters the configuration information for the inputs identified during the input and output identification step 215. For each input from the machine 15, the user enters a variable name and any transformations to be performed and/or rules to be applied by the engine 140. For each input, the user also enters the associated MMD 20 digital input connector 50, MMD 20 analog input connector 55, IP address for machines 15 providing Ethernet inputs, or MMD serial RS232/RS285 port 65. For example, for digital inputs, users may choose to flatten or invert the digital signal. For analog inputs, it is often desirable to specify a scaling method for the analog signal. For serial inputs, such as data received from bar code readers, it may be desirable to specify a bit mask. The variable names and the operations to be effected are eventually forwarded to the engine 140 for use in handling the inputs. This information is entered and viewed via web page user interfaces created by the configuration CGI module 170.

Next, during the output configuration step 245, MMD outputs and output variables are configured. These may include the generation of MMD 20 output signals, which are transmitted by the engine 140 via the output connectors 70. During this step, the user selects an output configuration option from the menu item on the configuration web page user interface. This causes the configuration CGI module 170 to generate an output configuration web page user interface. Using this interface, the user defines additional transformations that are to be effected by the engine 140 on the variables assigned to inputs in the input configuration step 240. The result of such a definition is a new variable, which can, if desired, be used as an input for another transformation defined during this phase of configuration. Thus, the user continually adds transformations and creates new variables until the user has defined variables that represent the information necessary for report variables. All of the variables and operations are eventually forwarded to the engine 140 which, once the MMD 20 is configured and operating, carries out the desired transformations on the variables and sends the resulting report variable to the database manager 175. Once the variables are established, the user may also choose to have any or all of them, including report variables, forwarded on to an Object Link Embedding for Process Control (OPC) server automatically for another application to access. For example, if a user desired that a digital input, input A, be inverted and compared for logical equivalence with another digital input, input B, the user would first define the variable names for each input during the input configuration step 240 and would also specify that the value of input A was to be inverted. Then, during the output configuration step 245, the user would specify that the value of input A is to be compared to the value of input B for logical equivalence and that the result be stored in another variable. The user could then define another transformation using the variable containing the result of the logical equivalence comparison. The result of this last transformation would be stored in still another variable defined by the user and associated with this last transformation.

The IP address of an MMD 20, UD 35 or server 37 that is designated to monitor the status of other MMDs 20 may be entered during the output configuration step 245. If such an address is entered and the user activates this monitoring feature, then, during initialization, each monitored MMD 20 will send machine status information (such as whether the machine is running or not) and the monitored MMD's 20 IP address to the designated MMD 20, UD 35 or server 37. Monitored MMDs 20 will only transmit new machine status information to the designated MMD 20, UD 35 or server 37 if there is a change in status. This information can be used by software, such as the web server 165, of the designated MMD 20, UD 35 or server 37 to allow the user to navigate from MMD 20 to MMD 20 in a list, such as a hierarchal tree, and view the reports and basic machine 15 running status of each MMD 20.

Proceeding now to the reports configuration step 250, the user defines and configures the reports. From the configuration web page user interface, the user selects the reports configuration option. This causes the configuration CGI module 170 to generate a web page menu of all the different report types. From this menu, the user selects the desired report type and the configuration CGI module 170 generates a web page user interface for entering and viewing the configuration information for a report of the selected type. The user then enters the required information for generating the report. This information includes the variable names to be used as the values displayed in the report. These are the variables that are stored in the database 180. Additional information, such as color information for graphs displayed in reports and labels for fields may also be entered. The user repeats this process for all reports desired.

For certain reports and values, the user may specify whether the engine 140 should send e-mail notifications, as well as the recipients, frequency, and delays of such notifications. The user may also choose to have all reports (that is, data sets) automatically forwarded by the reporter module 160 to a UD 35 or server 37 on the network 25 for archiving or use by another application.

The report variable names, report types, and structures to be stored in the database are eventually forwarded, via the configuration interface module 135, to the database manager 175 which creates a table for each report. Variables names to be monitored for e-mail notifications, as well as notification parameters, are forwarded to the engine 140. Report types and required information, such as variable names required and shift, time interval or color information, are forwarded to the reports CGI module 155 and, if the user has opted to have the reporter module 160 automatically forward reports in CSV, Microsoft Excel™, XML or other format to a UD 35 or server 37 on the network 25. The reports may be forwarded as generated or at given intervals.

Moving now to the save configuration step 255, the user may elect to save configuration information to the flash memory 100. If the user so chooses, the configuration CGI module 170 transmits the configuration information to the configuration interface module 135, which writes the information to the flash memory 100. The configuration interface module 135 may then access the configuration information in the flash memory 100 and forward the appropriate configuration information to the other modules. The user may subsequently alter the configuration by again choosing the configuration option from the initial web page generated when the MMDs 20 IP address is entered on the user's UD 35.

The above configuration procedure is provided as an example. It is not the intention of the inventors to limit the configuration procedure to the order specified above. It will be apparent to one skilled in the art that the order and content of some steps may be modified.

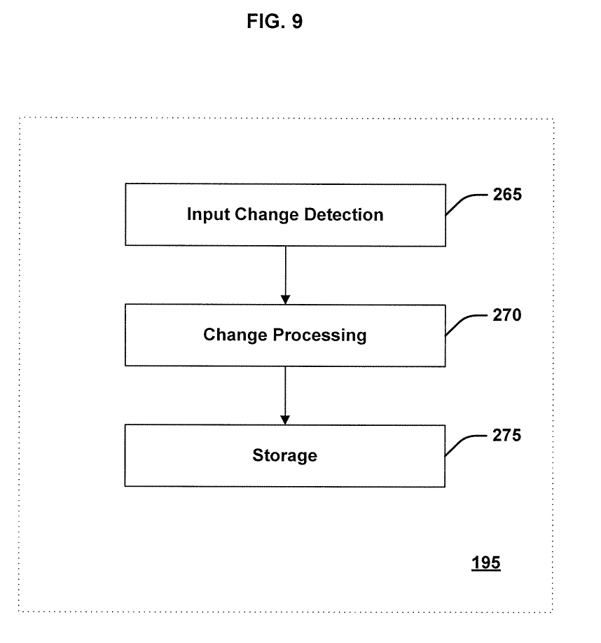

Reference is now made to FIG. 9, a flowchart showing the data acquisition or monitoring step 195 of FIG. 7. Beginning with the input change detection step 265, the engine 140 automatically monitors the machine 15 for input changes via the drivers 150. The engine 140 may also issue MMD 20 output signals and e-mail notifications during this step 265. For example, the engine 140 may be configured to issue an MMD 20 output signal or e-mail notification after the machine 15 has been in a certain state for 15 seconds. Thus, the state of the input will not have changed when MMD 20 output signal or e-mail notification is triggered. Next, at the change processing step 270, the engine 140 processes any detected input change by effecting transformations on the input change, which may result in changes to the values of report variables, and issues any MMD 20 output signals or e-mail notifications required as a result of the transformations. The transformations undertaken are based on the configuration information. Finally, at the storage step 275, changes in the values of report variables are forwarded to the database manager 175, which stores them in the appropriate format and table of the database 180, based on the MMD 15 configuration information.

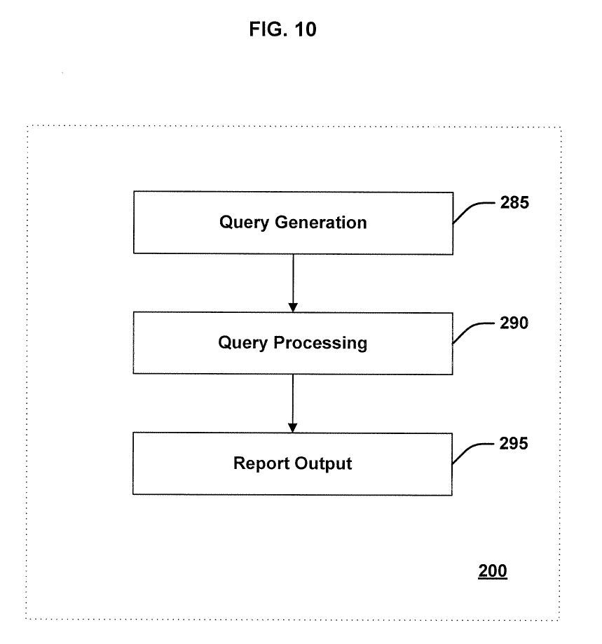

Reference is now made to FIG. 10, a flowchart of the reporting step 200 of FIG. 7 for automated reports. The MMD 20 may automatically generate reports at certain time intervals, depending on whether this option is chosen during the configuration step 190. Beginning with the query generation step 285, the reporter module 160 generates an SQL query and transmits it to the database manager 175. Next, at the query processing step 290, the database manager 175 executes the query by interrogating the database 180 and transmits the result back to the reporter module 160. Finally, at the report output step 295, the reporter module 160 receives the query results, transforms them into one or more reports in the format specified in the configuration information, and transmits the report over the network 25 to a CD 39. The report may be output in a format readable by CD 39 and/or by a database on CD 39, including formats such as XML, Microsoft Excel or CSV format. The report may be stored on the CD 39 for archival purposes and/or used by the user or other applications, such as factory/plant automation software. Reports can be stored on the designated CD 39 in a database or alternatively as a single continuous file for all reports or as a separate file for each period of time, which may represent a work shift within the production environment, as defined in the configuration information.

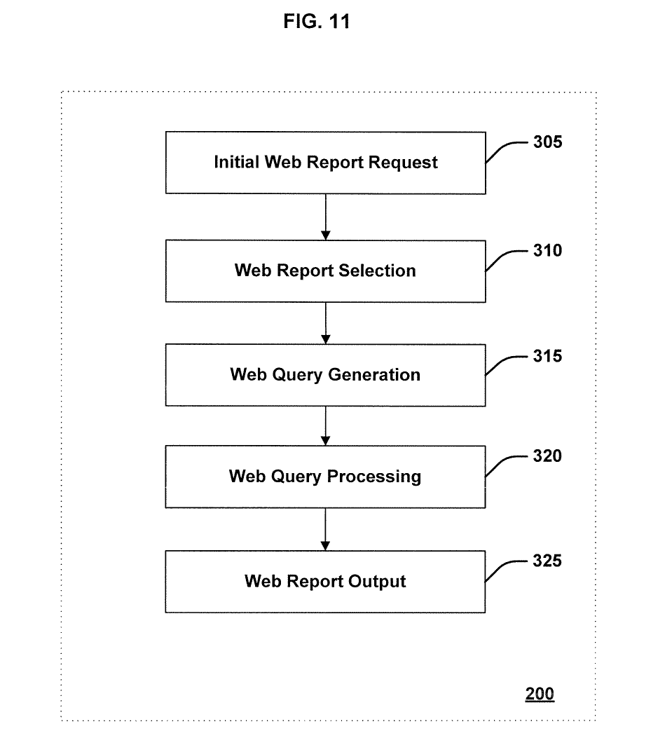

FIG. 11 is a flowchart of the reporting step 200 of FIG. 7 for user requested web page reports. Beginning with the web report request step 305, the user enters, for example, the name of the machine 15 the user would like to view a report on. For example, the report module may look up the IP address of the MMD 20 attached to the machine 15 the user wishes to view.

The web server 165 on the MMD 20 then generates an initial web page user interface menu from which the user may choose from a set of reports. The reports CGI interface 155 on the MMD 20 generates a report selection web page user interface from which the user may choose a report to view for that machine 15.

Next, at the web report selection step 310, the user selects a report from the web page report selection user interface menu. If the report selected requires that the user enter parameters for generating the report, the reports CGI module 155 generates a web page user interface for the desired report from which the user enters the required parameters. If, however, the report does not require a user to enter parameters, or if default values for the report were specified during configuration, the parameter entry web page user interface may not be displayed and the reporting will move automatically to the next step. These scenarios are not shown in FIG. 11.

Next, at the web query generation step 315, the reports CGI module 155 generates an SQL query, which is sent to the database manager 175. This query incorporates any parameters entered by the user during the web report selection step 310. Next, at the web-query processing step 320, the database manager 175 executes the query to obtain the desired information from the database 180 and transmits the results to the reports CGI module 155. Finally, at the web report output step 325, the reports CGI module 155 uses the information returned by the database manager 175 to generate a web page containing the report, which is then transmitted to the user's UD 35.

The reports CGI module 155 repeats the web query generation step 315, the web query processing step 320, and the web report output step 325 to capture and report changes in inputs and variables, as handled by the engine 140 and database manager 175. This allows the user to see the changes as they occur in real time. Also, as mentioned above, the user may specify during configuration that the reports CGI module 155 generate a series of default reports, using default parameters, which will appear as soon as the user identifies a particular machine 15 or associated MMD 20. In this scenario, not shown in FIG. 8, the web query generation step 315, the web query processing step 320, and the web report output step 325 are automatically undertaken for the default reports and parameters as soon as the MMD 20 is identified. The result is that the initial web page user interface menu generated by the web server 165 will display the default reports, generated by the reports CGI module 155 with default parameters, along with a menu of available reports and configuration options. Any reports subsequently chosen from the reports menu which also have default parameters specified will also be automatically generated by the reports CGI module 155 with these parameters when selected. The user then has only to enter specific parameters for reports where there are no default parameters or when the user wishes to use different parameters.

As described above, when an MMD 20 is configured, the user may define and configure reports for collected data. The user specifies the information required for generating reports, such as the variable names to be used as the values displayed in the report. Additional information, such as color information for graphs displayed in reports and labels for fields may also be entered.

In another exemplary embodiment, rather than having data displayed directly by the web server 165 and reports CGI interface 155 from the MMD 20, the web server 165 may pass data to a CD 39 in XML format for display using a report program (for example, a Flash program) that may also be provided by the MMD 20 for running within a web browser at the CD 39. Since each MMD 20 potentially aggregates data and generates reports from a different perspective as compared to other MMDs 20 in the system 10, it may be convenient for the MMD 20 to pass a specific report program related to its data. For example, an MMD 20 associated with a machine 15 involved in a heat sensitive process may record temperature. Similarly, an MMD 20 associated with a press may record the number of times the press is operated. It will be understood that there may preferably a base report program, which allows for the general display, and specific report functions for displaying particular types of data, such as temperature or number of operations.

Using a Flash or similar report program that is sent with the operational data allows computational and report generating tasks to be pushed to the CD 39 where the user can use the report program to manipulate the data. This allows easier scalability of the system 10 because MMDs 20 are less taxed by requests for data as the system 10 grows. In addition, this allows a greater level of interactivity and easier manipulation of the data since CD 39 is able to perform calculations locally instead of sending requests over the network 25 whenever the user wishes to view the data in a different manner. The use of a program to display reports and data instead of simpler HTML web pages allows both increased interactivity and reduced network load. Further, since the data and program will generally be retained in the web browser's cache, they may not need to be retransmitted if needed again and have not yet expired from the cache. Since MMDs 20 can be configured to transmit limited data, for example, averages, or points where data has changed significantly, instead of the raw data containing every measurement, the amount of network traffic needed to transfer the data from an MMD 20 to a CD 29 for display is again reduced.

For example, FIG. 12 shows an exemplary report showing a main window and several secondary windows showing variables of interest, and in particular, timelines for various variables for a particular machine 15, where the timelines represent machine production, machine status, a signal chart (for example, machine temperature), and alarm status. Any other variable monitored, such as job ID, employee and the like, may also be represented. In this example, the MMD 20 sends the relevant data and a Flash report program to the CD 39 which is responsible itself for calculation, drawing charts or graphics, and showing results to the user. If the user wants to change the view, it can be calculated and reported locally by CD 39 without making any further demands on the MMD 20. In this particular example, the user has the option of changing the position of any of the secondary (variable) windows so that the user can see the effect of superimposing one variable on another, for example, moving the machine status window onto the production window so that it is easier to relate the variables to each other and determine the possible cause of lower or higher production. This allows the user to perform interactive data-mining to determine the impact of variables on each other. Alternatively, superimposing the alarm status on the machine status can give an indication of the length of time required to deal with an alarm situation. Since these graphic images are manipulated locally, there is no further network traffic required to retrieve and show graphical images, they may be manipulated in a more interactive fashion.

In a similar way, a user may also be able to zoom in or out of a timeline view smoothly by dragging a slider or the like. Certain windows could be hidden or revealed while the user determined what was of interest or relevance. For instance, if a machine temperature timeline were juxtaposed with an alarm timeline, it might be possible to see that it was high temperatures causing alarms. If an operator ID timeline was also shown, it might be possible to see that a particular operator caused more alarms than his peers and might require additional training.

Now, having described the MMD 20 and its elements of the management software 600 providing functionality for real-time data acquisition, processing and output, the following description relates more generally to the operation of the management software 600 (described generally above in relation to FIG. 4) at a system level. At the system level, the management software 600 that makes use of the operational data from the MMDs 20 and provides for financial data input and further report and user interface functionality.

As described above, the management software 600 provides various user interfaces for viewing data within the system 10 and data structure 400. The elements and functionality of the management software 600 can be understood by considering the user interfaces.

In a hierarchical user interface, a chart such as that shown in FIG. 2 is available, allowing a user to request information down to the level of individual MMDs 20. In the case that a user requests information related to a single MMD 20, the process of report generation described above can be performed to provide the user with a report or reports related to a particular machine. If a particular case, the machine status of each machine 15 attached to an MMD 20 can be obtained by moving a mouse pointer device over the MMD 20 attached to the device on the list of MMDs. When a user selects an MMD 20, a reports request can be sent to the MMD 20 selected. Subsequently, the request can be handled by the web server 165 and reports CGI module 155 of the selected MMD 20 as described above. In a particular case, all of the web report pages and menus generated may be shown within a frame allocated for report viewing, while the hierarchical view remains available. The user may then navigate to another MMD 20 to view its reports by clicking on the MMD 20 within the frame containing the hierarchical list of MMDs 20. In this fashion, the user may view the reports available from a variety of MMDs 20 in succession. As described above, when data is retrieved from a particular MMD, it can be held within a cache so that the next time a user clicks on the MMD 20, the CD 39 can determine if the data is available in the cache prior to sending a request to the MMD 20.

When a user would like a report for more than one MMD 20, the management software 600 may allow a user to select more than one MMD 20 from, for example, the hierarchal tree. In this case, since the internal nodes of the data structure 400 typically store the same information (or a sub-set thereof) as their children, it may not be necessary to access the actual MMDs 20. Instead, the information may be accessed from the department node or even a higher-level node. The particular node accessed depends on how timely and the amount of data required. For example, at one extreme, if the information is very specific, and the most recent data is required, a particular MMD 20 may be accessed as described above. On the other hand, if a large amount of data is required but its timeliness is less of a concern then it may be desirable to access the organization node (root of tree). To obtain the same information without accessing the root may require one to access many different nodes since the information may be spread out over various facilities and departments. Thus, the distributed, cross-referenced data structure 400 has the advantage of minimizing network traffic. The data structure 400 also avoids unnecessarily taxing the processing power of nodes, such as MMDs 20, and leaves them free to perform their other duties. It will be understood that, in the case of seeking information from a particular MMD 20, it may also be possible to access the data from a higher level node, particularly if the real-time operating data is not needed.

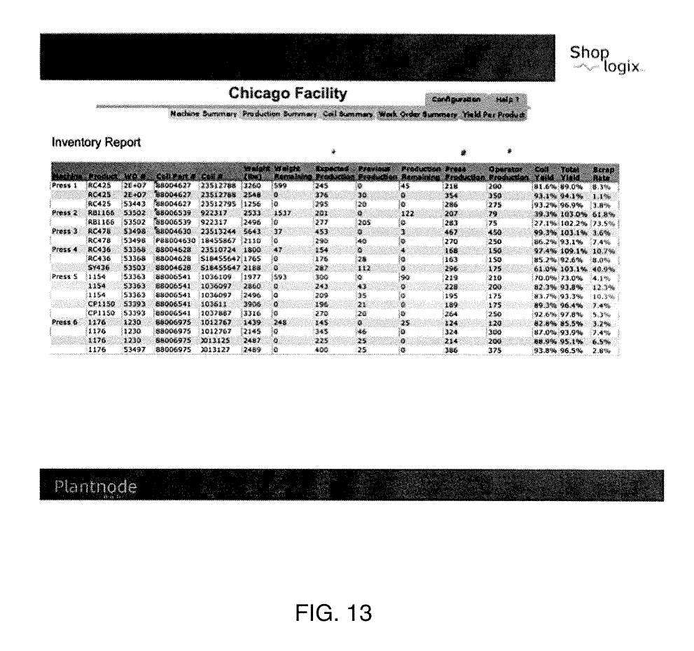

FIG. 13 illustrates an exemplary report generated from a plurality of MMDs 20. The report shown is an inventory report that includes a number of pieces of information for presses at a manufacturing facility. The values presented include weight remaining, expected production, press production, and operator production and various yield rates. It will be apparent that some values such as weight remaining will be determined in real-time from the MMD 20 while values such as expected production may be input at the start of a task/job or may be calculated based on the initial weight/size of the coil and the weight of each part produced. Further, yield rates and scrap rates may be calculated/derived from weight of the product, expected production, actual press production and the like. This data and information can provide insights into the efficiency of certain machines and workers. The type of information in this report can further be combined with rules to provide alerts or warnings by e-mail to users. For example, a mismatch between the expected production and actual production along with a low scrap rate may indicate that the material used is not of an appropriate thickness. As explained in further detail below, if appropriate rules have been entered, then it is also possible to combine this operational data with financial data so that prioritized alerts or warnings can be generated for users in roles such as purchasing or quality.

Because data is available at any time from MMDs 20, instantaneous or real time reports can easily be generated at any time and issues or problems identified and corrected more quickly instead of waiting for weekly or monthly reports which may obscure the problems. In addition, if an MMD 20 monitors each machine 15 in a facility, the status of a manufacturing plant as a whole at any time is easier to capture correctly.

### Tactical Information

As described above, the MMDs 20 are particularly adapted for real-time acquisition, processing and reporting of operational data. The following description focuses on the acquisition and processing of financial data as it relates to the operational data by the system 10 and management software 600. Financial data may be acquired/entered in a variety of ways. For example, financial data such as labor rates, machine costs, machine hourly rates (margin or opportunity) and the like, which will remain relatively fixed or which may be reviewed on a known basis, such as an annual or other basis, may be entered or amended when necessary by use of the configuration module 605 described above. Job specific financial data, such as opportunity cost if the job is delayed, margin cost for each defective piece, material or scrap costs or the like can be entered via a UD 35 when the job is entered into the system 10 or can be entered via an MMD 20 (possibly with a bar code scanner or the like) via the configuration module 605, for example, when a job reaches the factory floor. It will be understood that some financial data may also be acquired from other databases or systems within the organization such as enterprise resource planning (ERP) systems or the like. It will further be understood that, like other configuration settings, the financial data may be reviewed and altered in real-time based on any new information received.

The functionality of the management software 600 and the use/impact of the financial data can be further understood by considering a role-based user interface for the management software 600 and the information displayed using the user interface. FIGS. 14A-H show an exemplary role-based user interface 700 for the management software 600. The role-based user interface 700 may be displayed on any CD 39 that is connected to the network 25. In an initial screen, the role-based user interface 700 includes a central display area 702 surrounded by a plurality of icons 704. In the illustrated embodiment, each icon 704 is an orb represents different roles within an organization.

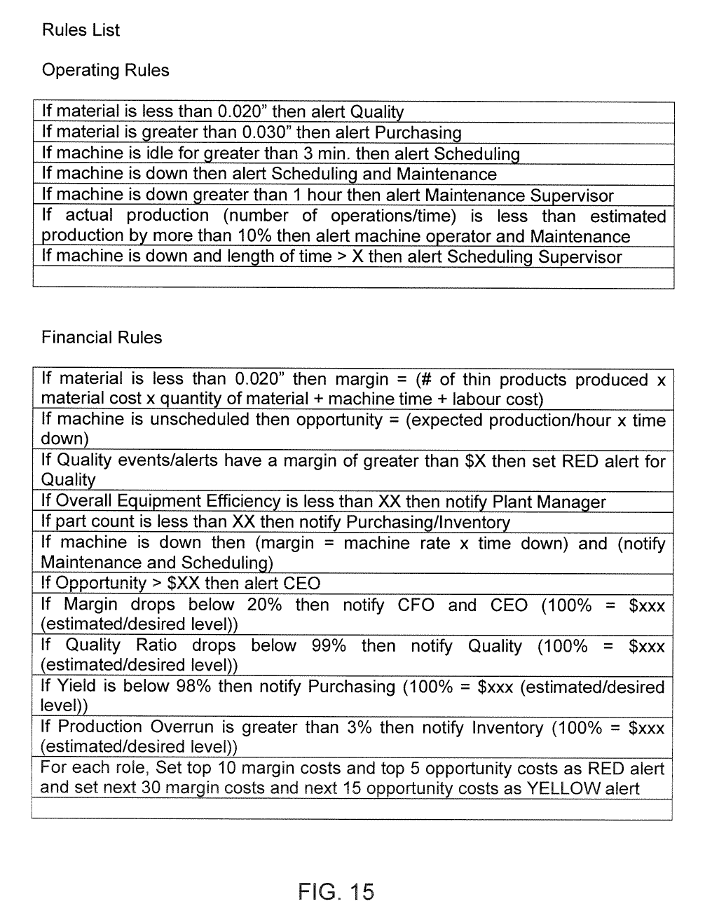

In the example embodiment, central display 702 is arranged to display three different categories of information. The three categories include information related to margin, metrics and opportunity cost. These categories are shown for illustrative purposes only and are not meant to be limiting. In FIG. 14A, central display 702 is displaying information related to metrics and includes buttons 706 and 708 for switching to other categories of information. When another category of information is displayed, one of buttons 706 and 708 will allow a user to switch back to the metrics information. As shown in FIG. 14A, the metrics category displays information related to overall metrics (key performance indicators (KPI)) such as overall equipment efficiency (OEE), Equipment Availability, Product Quality and the like. As will be understood, this display can be configured for the KPIs for the particular organization. As shown in FIG. 14B, the margin category displays information related to margin, that is, some measure of the impact that the operational and financial data will have on the cost of or efficiency of production, such as scrap cost, staffing cost, raw material cost and the like. As shown in FIG. 14C, the opportunity category displays information related to opportunity cost that may have an impact on future work from a customer, high value jobs vs. low value jobs, such as downtime, quality, productivity, scheduling and the like. In each case, the various measures that are displayed may be configured or may be selected based on their relative importance based on dollar value or the like. In each of these categories, central display 702 can display various columns of information reflecting different time periods or the like. This gives an indication of how a particular measure is changing over time. The actual determination of the values for metrics, margin and opportunity costs is described below with regard to FIG. 15.

In the user interface 700, a user may select any of the various icons 704 on the outside of the central display 702 in order to access additional information related to the role represented by the icon. When this occurs, the central display 702 may change to display information related to that role, such as events or tasks to be reviewed or undertaken by staff in the role. For example, if the quality orb were selected, the central display 702 would display quality related information. Alternatively, when a user selects an icon 704, the central display 702 and icons 704 may move to the side and a new element/window 710 will display role-specific information as shown in FIG. 14D-F.

As shown in FIG. 14D-F, role-specific information may include a list of events with related information such as duration, machine name, operator, job number, and profitability metrics such as margin costs and opportunity costs. With regard to the specific roles shown in FIG. 14D-F, some examples of the various metrics that may be tracked and notifications or alerts that may be generated are provided as examples of the types of data that may be tracked and used within the system 10.

For the scheduling role (FIG. 14D), metrics include: mean time between jobs (line/machine idle because nothing is scheduled to run=“no work”) or low runspeed due to poor scheduling (some products may run faster on alternate machines/lines); and related notifications or alerts may include: notification of large job variances, for example, greater than 10% of estimate (if too fast or too slow—schedulers need warnings of jobs that are outside of expectations so that there can be a continuous review and updating of the scheduling system); % complete; and alerts regarding large deviations so that other scheduled jobs can be adjusted—possibly by providing this tactical data/information to a separate scheduling tool or the like.

For the quality role (FIG. 14E), metrics include: quality ratio (by machine, aggregate for plant, etc.); number of defects (scrap); or first time through (FTT); count or percentage and related notifications or alerts may include: alerts on failures captured from scrap notifications, notifications or alerts when a quality/speed ratio is exceeded (for example, if line speed is excessive and this is known to cause quality problems a value can be obtained that will generate an alert if exceed).

For the purchasing role (FIG. 14F), metrics may include: yield factor; material shortages; quality rejects related to material issues; low runspeed due to poor raw materials; and related notifications or alerts may include: alerts when material consumption rates indicate that re-orders are needed; or alerts related to materials being too thin/thick and leading to greater or less than expected production.

Other roles in a manufacturing environment may include: maintenance, material handling, shipping/receiving, inventory control, sales/customer service, engineering, accounting/chief financial officer, production supervisor, plant manager. Metrics that may be used to generate alerts may include: mean time between failures, response times, machine/line availability (%) or utilization, mean time between material shortages, inventory turns, inventory value (opportunity cost), margin per job/salesperson, variance from estimates/standards, machine/overall downtime, overall equipment effectiveness. It will be understood that each organization or facility may configure the system 10 for the particular roles, metrics, rules and notifications/alerts that will apply within the organization or facility.

As shown in FIG. 14G-H, a user may also “drill-down” to further information within each of the roles by clicking on display elements to view the data that resulted in the displayed element/alert. For example, as shown in FIG. 14G, a user may drill-down on a metric indicating that material is too thin/thick on a press and have the thickness variable displayed as a graph showing the desired range of thickness so that the nature of the alert/event can be more easily identified. Although FIG. 14G and FIG. 14H show similar data, depending on the manufacturing process, the quality role may be concerned if the material is too thin (poorer quality) whereas the purchasing role may be concerned if the material is too thick or too thin (increased costs due to too thick or increased levels of scrap due to being too thin).

The management software 600 and user interface 700 may also be configured to display information for a hierarchy of levels within a role. For example, the hierarchy can provide information needed for a given level of responsibility within the role, such as a plant, team or individual. In the example shown in FIG. 14A-D, a user first selects an icon 704 and a list of overall role specific information will be displayed as shown for example in FIG. 14D. If there are additional hierarchical levels, the display may also show additional buttons or links to allow a user to access other hierarchical levels within the selected role, such as information that is specific to a plant or assembly line within a plant or the like. This allows for the provision of information specific to a particular unit of responsibility. This in turn makes clear which person or team faces a particular event/alert and allows for an appropriate response to be taken by that person or team. It will be understood that each user may have their login information configured to first present them with a screen showing events/alerts/tasks related to their particular sphere of responsibility, however, as described below, they may also be given access to additional levels.

In the role-based user interface 700, the various icons 704, events, or other components can be made to look different depending on the level of urgency of an event/alert in a given area. For example, an icon 704 could be colored differently to indicate different levels of urgency. As an example, not intended to be limiting, blue could be used to represent neutral, indicating no problems of any significance, yellow could be used as a first warning sign, indicating that there is at least one problem, orange could be used to represent an escalated level of urgency, and red could be used to indicate a high level of urgency. This scheme allows a person to, at a glance, have a complete view of the operational health of the organization to which he/she belongs. It also gives an indication of which areas face the greatest difficulties and where efforts should be concentrated for improvements.

The role-based user interface 700 can also be designed to provide different levels of access. At one extreme, all users could have access to all the information in the various roles and levels within a hierarchy. This provides the highest level of transparency and allows each user to have a complete view of the entire company or organization. It further facilitates the exchange of information and allows a person of one role to have a complete view of another role and potentially provide suggestions to that other role.

At the other extreme, each user may be given access to only the information specific to their role or hierarchical level. Alternatively, each user can be granted complete access to the information with respect to their own role but only limited access, to each of the other roles. In addition, the amount of access that is granted to each role can vary from role to role.

Reference is now made to FIG. 15, which illustrates examples of rules relating to operational data and rules that relate to financial data as applied to operational data. The rules are used by the rules processing module 625 to determine the metrics, margin and opportunity costs, and the like that are output via the role-based user interface 700 described above.

Rules are generally entered as part of the configuration process discussed above and can be modified by reentering a configuration process. Some rules may be entered well in advance (e.g. employee wages for idle time opportunity cost calculations, etc.) while other rules that are job/production run specific may be entered at the time a job/task is entered into the system 10. As shown in FIG. 15, rules can generally be thought of as falling into one of two types, those relating to operational data and those relating to financial data. In either case, the rules can also be related to roles within the organization. The first type of rules involve an analysis of operational data to determine variances in the operational data, such as a variance from a particular standard or an average that is expected to be met or that could cause problems if not met or if exceeded. The rules may also include some indication relating to the amount of the variance, for example, using a threshold value or the like. In many cases, these rules also relate to the generation of an event or alert (and a particular alert level) if the variance is significant. The second type of rule involves an analysis of the financial impact of the operational data by applying a financial measure of, for example, margin cost or opportunity cost. For example, for a worker on a machine 15, rules could be entered for the total expected production, the expected yield and so forth. The MMD 20 would then take raw data such as the number of operations of the machine and the number of work pieces produced to generate operational data such as actual yield. The actual yield is then compared to the expected yield and, if not within a predetermined range, an event/alert can be generated for the appropriate role in the organization. The operational data such as actual yield and expected yield can be processed by the second type of rule relating to financial data to calculate a margin value that reflects any loss related to the difference in value, for example, the lost material cost for the short-fall in yield. A financial rule can also provide an opportunity cost value, for example, related to the time lost from having a machine 15 unscheduled or an unplanned downtime. The application of the financial rules to the operational data allows for prioritizing the events/alerts from the operational data in a tactical way so that financially more important issues can be handled first. The rules can specify when an event/alert should be displayed, the level of the event/alert (for example, caution, escalate, urgent, or the like) and can also define conditions under which further instructions or escalating instructions are sent to persons in specific roles and at various levels. In general, the event/alert is also intended to escalate or expand with the knowledge learned about a particular situation. In this way, it is possible for a particular event/alert to be addressed with more intelligence the next time and hopefully minimizes its impact or potentially eliminates it from happening again. It will be understood that rules combining operational and financial data may also be prepared. It will also be understood that rules may be related to each other and/or nested such that rules may be based on a result of another rule. It will also be understood by one of skill in the art that the rules illustrated in FIG. 15 are in an “if . . . then . . . ” format but other formats are possible and other methods of processing rules, such as fuzzy logic or the like may be applied within the system 10.

The rules indicated in FIG. 15 are exemplary and are not meant to be limiting in any way. Typically, a person who is familiar with the work done by a specific role will enter these rules. However, the person who enters the rules need not necessarily be the actual person in that role. In certain cases it may not be appropriate for the actual user to enter the rules. For example, in the case of a machine operator, allowing such a user to set the rules might be the equivalent of allowing him/her to set the standards by which he/she is measured. Moreover, individual rule setting might allow for varying standards between individuals performing the same work. In such a case, it may be desirable to have a supervisor set the rules for his/her subordinates.

The rules are a part of the rules processing module 625 of the management software 600 and can be stored at any appropriate location from which the rules can be obtained via the management software 600 and the network 25. In the case of a specific machine 15, it may be appropriate for the rules related to the operational data from the machine 15 to be stored and processed on the MMD 20 that monitors that machine 15. In the case of a rule not associated with a particular machine 15, the rule can still be stored on a specific MMD 20 or alternatively, they can be stored on another CD 39 with an appropriate part of the rules processing module 625 of the management software 600. In any case, the rules processing module 625 monitors incoming data from the data acquisition module 620 and processes the rules related to the incoming data to determine whether any of the conditions in the rules have been met. This can involve accessing data from various MMDs 20, CDs 35 or servers 37 in order to obtain the information necessary to process the rules.

The rules may also include information related to the timing at which the rules are to be processed. For example, certain rules could be monitored in real-time, such as monitoring the thickness of material in a press, other rules might only be monitored at a predetermined time interval, such as the actual quantity of products produced.

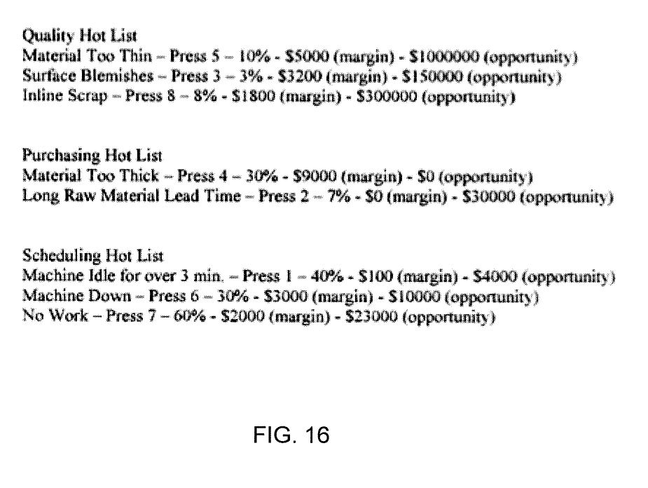

Reference is now made to FIG. 16, which illustrates additional examples of events in a list format, sometimes referred to as “hot lists” for various roles. The hot list is a list of role specific events or alerts that can be prioritized based on various financial data such as opportunity cost or impact on margin or the like. The hot list will generally be displayed on the role-specific screens within the user interface 700, such as those shown in FIG. 14D-F. The hot list preferably contains the most urgent matters to be dealt with in the specific roles based on the degree of difference from specification (i.e. 10% off from expected value), the margin value, the opportunity value or some combination of measures of importance. The hot list may provide a limited number of role-specific matters based on the priorities. For example, the hot list may be limited to only the top five or top three most urgent tasks. The hot list thus provides an individual or team in a given role with a prioritized (and possibly limited) number of things that can be done to improve the operational situation in his/her role/area.

Hot lists are generated based on the rules described above. The management software 600 acquires the operational and financial data via the MMDs 20 and other sources, applies the rules and creates the hot lists. In some embodiments, the processing is performed in real-time. Once generated, the hot lists are available on the network 25 via the role-based user interface 700 or, in alternative cases, can be pushed to appropriate CDs 39 or users or can be requested by a user through a UD 35. Further, the management software 600 and user interface 700 may also be configured to allow users within a role to reassign tasks that appear in a hot list. For example, a user that realizes that a particular task cannot be completed by his department or within his/her shift can reassign the task to another department or individual's hot list. This can be performed, for example, by right clicking on a task and selecting a “reassign” menu item or the like.

One benefit of the tactical management software 600 is that the events and alerts (as well as the financial impact) are provided in real time. Thus, if a problem is detected with a particular machine (e.g. running slow, down, or the like), the hotlists for maintenance can be updated based on the financial impact of the problem and further notifications can be issued as appropriate. This allows for the financially more important issues to be handled first. The hotlists assist in focusing people on tasks that are more important and valuable to the organization.

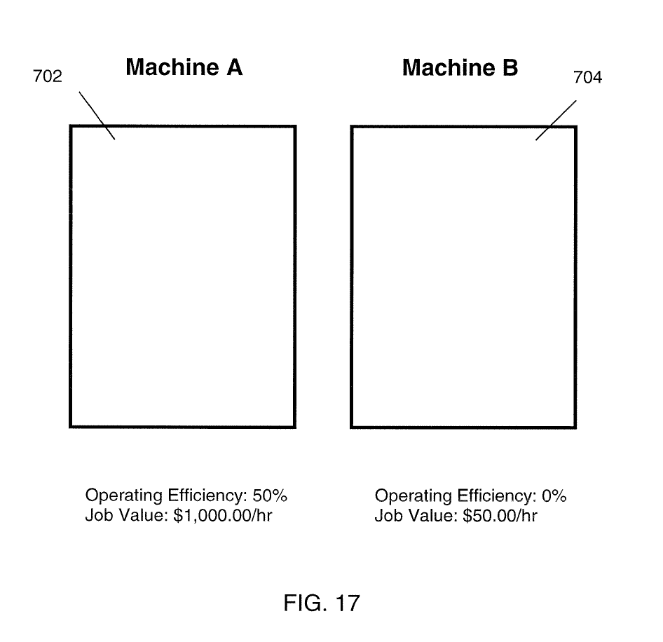

The management software 600 also has the benefit of providing not just raw data, but tactically useful information to users. In many cases, this information may be very important but would not otherwise be available to the person. The provision of this tactical information empowers people to make more intelligent decisions. A simple example is illustrated in FIG. 17. If there are two machines that are not working at full efficiency, then a maintenance worker may have to decide which of the two to fix first. If as illustrated in FIG. 17, one machine 802 is operating at 50% efficiency and the other machine 804 is completely down then it seems logical to fix the machine that is completely down first. However, if the work that is to be done on machine 802 is worth $1000 per hour and the work on machine 804 is worth $50 per hour then, all else being equal, this choice is incorrect. If appropriate financial data regarding the worth of the jobs and appropriate rules are entered then the management software 600 could provide the maintenance worker with appropriate information regarding which machine should be attended to first. By doing this, the management software 600 has assisted the maintenance worker in making a correct decision with respect to opportunity cost and financial impact.

The above example is meant to be illustrative only. The management software 600 could direct a worker to a machine based on any other criteria as well by giving him or her information that may not otherwise be available to him or her. For example, the management software 600 could direct the worker to a machine that is a bottleneck in the production line (because of a low actual production rate compared to expected production rate) first over another machine on the production line that may be running slowly but that is not delaying the production line because it is downstream from the machine causing the bottleneck. Without the management software 600, the maintenance worker may not know which machine is the bottleneck and it may be difficult for him or her to obtain this information.

As the above examples illustrate, the management software 600 allows people in different roles to have a more complete picture of the organization and to take action in accordance with the overall needs of the organization. In short it allows individuals in different roles to view the organization in the same way and to act in manner that is not only beneficial to the organization but is coordinated with the acts of people in other roles. This is accomplished through appropriate monitoring of inputs by MMDs 20, the entry of the relevant rules during the configuration process and otherwise, the generation of appropriate information and the processing of appropriate rules.

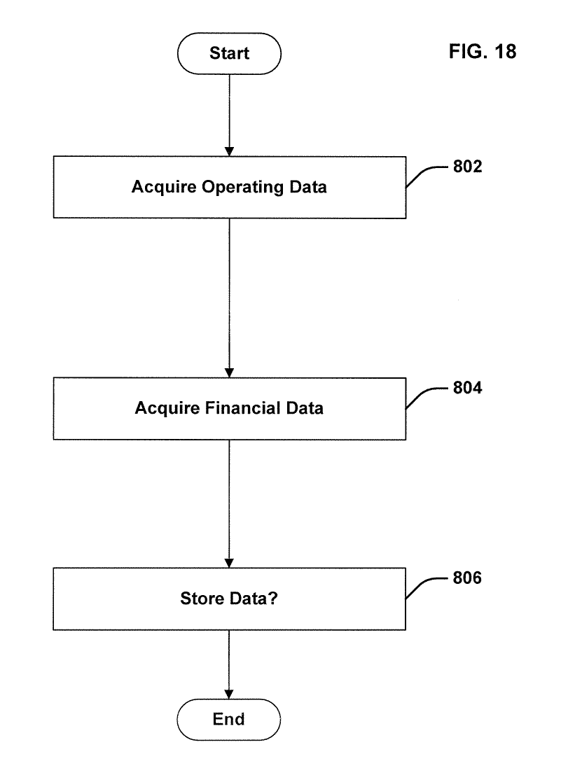

The following discussion provides further details on the modules of the management software 600. Reference is now made to FIG. 18, which is a flowchart illustrating a method by which the data acquisition module 620 of the management software 600 monitors inputs and stores data. At step 802 the system 10 acquires operational data from the MMDs 20 related to the machines 15 to which they are connected. As described above, the operational data may be raw data from the machines 15 or data that has been subject to processing by the MMD 20. At step 804, financial data is acquired. The financial data may be acquired from MMDs 20 (for example, from a scanned work order) or from CDs 39 (for example, a salesperson entering an opportunity cost related to loosing future work from a particular customer, a purchasing person may enter the opportunity cost of having long material lead times or the scheduling opportunity cost of running similar jobs back-to-back versus aligning similar jobs with operators that run these jobs more efficiently. The amount of data (either operational or financial) collected and the variables that the data can relate to are not fixed. For a machine 15, the data collected could be any number of variables and could be related to a variety of financial measures as would be known to those of skill in the particular area of manufacturing.

Then at step 806 the data acquired in the previous two steps is stored. These steps are only meant to serve as examples. In particular, as described above, not all the data that is collected needs to be stored on a longer term basis. Some of the data could simply be processed and/or displayed and not stored. For other data, it may be more meaningful to store an average value over a given time period. The manner in which data is stored, processed and displayed can be determined during the configuration process.

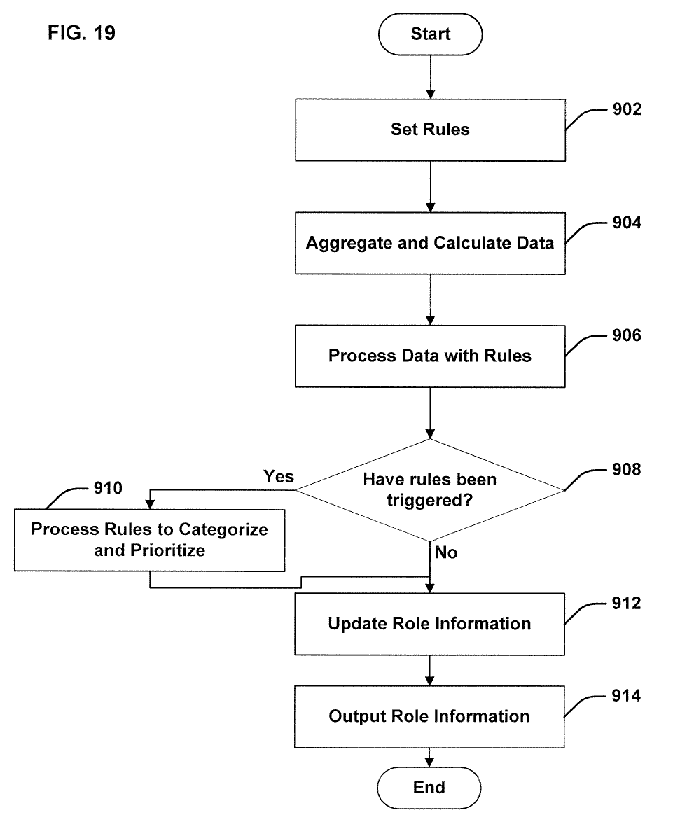

Reference is now made to FIG. 19, which is a flowchart illustrating an exemplary method by which the rules processing module 625 of the management software 600 functions. At step 902, the rules are accessed. As explained above, the initial entry of rules is generally part of the configuration process for the system 10 and relates to the configuration module 605 of the management software 600.

At step 904, the rules processing module 625 aggregates data related to the rules being processed. In particular, the management software 600 accesses operational data and financial data from the various MMDs 20, CDs 35 and/or servers 37. The management software 600 need only access data that is relevant to the specific rules being processed.

At step 906, the rules processing module 625 processes the data aggregated in the previous step using the rules. In particular embodiments, where necessary, the management software 600 may also make any appropriate calculations at this step as well. (For example, if a rule is “If the quantity of scrap times the value of raw material is greater than $XX, then alert maintenance”, then it is first necessary to calculate the quantity of scrap X the value of raw material.) In processing the rules based on the data, there may be several rules that are not triggered and several rules that are triggered. The management software 600 determines all rules that are triggered, determines which rules are priorities based on the financial impact of the rule. For example, if there are 10 different rules that require an alert to purchasing, a list will be created containing all 10 alerts, however, the alerts will be prioritized based on the financial impact (i.e. based on a predetermined formula based on the margin and opportunity values associated with the rules) to produce tactical role-based information. In a particular embodiment, if an event/alert is generated that does not have financial data associated with it, the management software 600 may request a user to enter financial data related to the event/alert. The management software 600 may also combine one or more of the results of rule application using additional rules (for example, “If quality is alerted and scheduling is alerted, then also alert sales by sending an e-mail message.”).

At step 908, it is determined whether any of the rules require specific warnings or instructions to be sent directly to a user. If yes, then at step 910, any appropriate warnings or instructions are prepared for the user. If not, step 910 is bypassed. Then at step 912, the rules processing module 625 of the management software 600 updates status levels in each role-based area. As described above, there could be various status ranges specified corresponding to the various colors discussed above with respect to FIG. 14.

At step 914, the rules processing module 625 outputs appropriate information to the output module 635. After step 914 is completed step 904 is repeated.

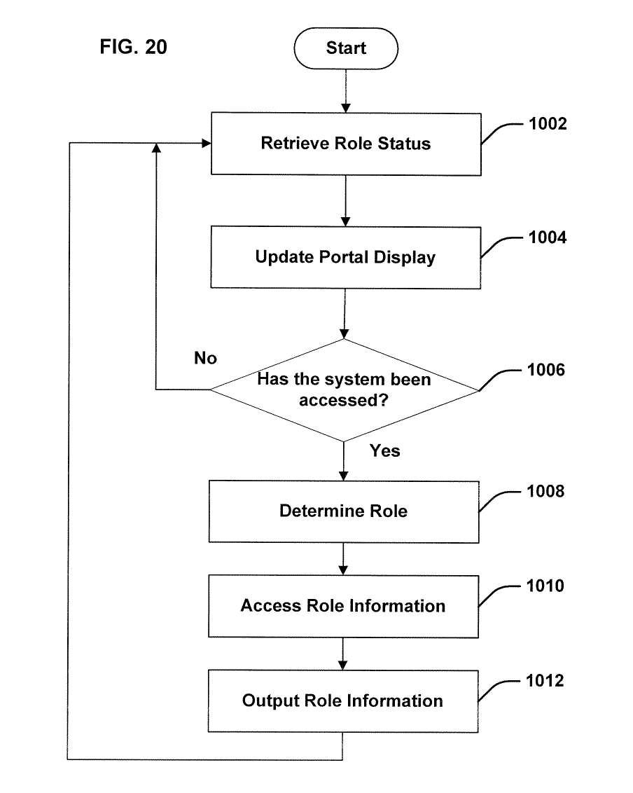

Reference is now made to FIG. 20, which in a flowchart illustrates an exemplary method by which the output module 635 of the management software 600 controls the user interface 700. At step 1002, the management software 600 accesses the status of each role. It then, at step 1004, updates the portal display by displaying each role symbol according to the status. The output may be output via the role-based user interface 700 described above with reference to FIG. 14. For example, if there are any urgent matters related to the scheduling role, the scheduling icon 704 can be changed in color to indicate the urgent status. When a user accesses the scheduling icon 704, for example by clicking on it with a mouse or the like, further details of the alert status can be displayed as described below. As mentioned above, the alert status can also be output in a variety of other manners. If the alert is urgent, such as a warning, then the output module 620 may send an indication/alert to a particular UD 35 or other device. For example, this could be done by sending an email. In other cases, less urgent information can be presented on a user interface through MMD 20, UD 35 or server 37. As the data acquisition module 615 and rules processing module 625 are continuing to operate, the information being output through the output module 635 can also be updated regularly, potentially in real-time as data is received.

At 1006, it is determined whether or not a user has accessed the role-based user interface 700, by, for example, choosing an icon representing a particular role. If not, then the method returns to step 1002. If yes, then the management software 600 proceeds to 1008. At 1008, the output module 635 determines the role for which the information is required.

At 1010, the relevant role information is accessed, which may include, for example, hot lists such as those shown in FIG. 16 or the like. Then, at 1012, the management software 600 outputs the relevant role information to a display screen. Again, as the data acquisition module 615 and rules processing module 625 are continuing to operate, the information being output through the hot lists can also be updated, preferably in real-time. As described above, the management software 600 may further allow “drilling down” into additional information, related to a particular alert or within subdivisions in a particular role. After the relevant role information has been reviewed and printed or the like, the management software 600 can then be returned to 1012, either by user action or perhaps automatically after a predetermined period of time.

The above disclosure describes exemplary embodiments of a method of managing manufacturing information within an organization. The method generally includes: acquiring operational data; acquiring financial data, applying rules to the operational data and the financial data to: generate alerts based on the application of the rules; categorize the alerts based on roles within the organization; and prioritize the alerts based on financial impact.

In determining the financial impact, it will be understood that the rules may include calculating an effect of the operational data and the financial data on financial performance. In particular, the financial data may be data relating to opportunity costs and/or may be data relating to margins or some other financial indicator. Similarly, the rules may include information relating to the roles within the organization.

As noted above, the range of operational data inputs is very broad and is not limited to the MMDs 20. In alternative embodiments, the system 10 may incorporate biometric data entry devices (not shown) such that an employee will provide biometric data to track time and attendance, track employee activation of a machine 15, or the like. The system 10 could then gather information related to employee performance to show to a machine operator his/her real-time performance, compared historically to himself, or with others and provide immediate feedback, when it is most useful.

Also as noted above, the system 10 is intended to provide various benefits in generating tactical information. As another example, scrap reports could be made more useful. Instead of only tracking that a certain amount of inputs were made and a certain amount of output resulted, the system 10 is intended to identify more clearly which machine(s) 15 produced the defective parts, which operator shift was running at that time, and, in some cases, even which operator was responsible. The system 10 is intended to be able to then aggregate data to further identify which job was affected by the loss, and report at a job level instead of just at the machine level, together with financial information calculated by applying financial data to the operational data. Such information can lead to variance reports being made more useful as well since job specific costing can be made more accurate because estimated cost versus actual cost is easier to compare and thus future estimates easier to make. Without using system 10, reports are usually produced weekly or monthly and unless jobs are started and ended on the weekly or monthly boundary, it is difficult to extract the relevant data out of the aggregated report.

As well, the real time nature of the system 10 is intended to allow improved efficiency by identifying production bottlenecks in real-time. The system 10 is intended to be better able to identify which machines are starving for work (waiting for inputs), and which machines 15 are blocked, or waiting for other machines 15 to accept their output. Since the system 10 has job specific financial data available to it, the system 10 should be able to calculate whether it is economic to divert production to or from other jobs to increase efficiency. In addition, the system 10 should be able to compare the scrap rate of each machine 15 to a historical average and identify immediately, whether there is a problem so that machine service can be performed or perhaps operator assignments rearranged.

It will be understood by one of skill in the art that elements of the embodiments may be embodied in hardware, in software, or in some combination thereof. Although elements of the embodiments have been described as modules, the distributed nature of the system 10 means that the modules may also be distributed. Also, software or program elements may be stored on computer readable media, which media may include various types of computer memory, computer disks, digital or analog signals, or the like.

While certain features and elements have been illustrated and described herein, many modifications, substitutions, changes, and equivalents will be apparent to those of ordinary skill in the art.

We claim:

1. A system for managing data within an organization, the system comprising:
a data acquisition module for acquiring:
operational data; and
financial data related to the operational data;
a data processing module configured to:
analyze the operational data to identify a variance in the operational data;
determine a financial impact of the variance based on the financial data;
generate an event based on the variance in the operational data; and
prioritize the event based on the financial impact; and
an output module for outputting the event.

2. A system according to claim 1, wherein the financial data is data relating to opportunity costs.

3. A system according to claim 1, wherein the financial data is data relating to margins.

4. A system according to claim 1, wherein the financial impact is determined by applying the financial data to the operational data and calculating a value attributable to the variance in the operational data.

5. A system according to claim 1, wherein the data acquisition module acquires financial data for a task at the time the task is scheduled.

6. A system according to claim 1, wherein the output module outputs the event in accordance with the prioritization.

7. A system according to claim 1, wherein the operational data is real-time operational data and the data processing module operates on the real-time operational data.

8. A system according to claim 1, wherein the data processing module is further configured to categorize the event as relating to a role within the organization.

9. A system according to claim 1, wherein the data processing module comprises a rules processing module for applying rules to the operational data and financial data to identify the variances and to determine the financial impact.

10. A system according to claim 9, further comprising a configuration module for entry of the rules.

11. A system according to claim 9, wherein the rules comprise information relating to roles within the organization.

12. A method for managing data within an organization, the method comprising:
acquiring operational data relating to operations of the organization;
acquiring financial data related to the operational data;
automatically analyzing the operational data and the financial data to:
identify a variance in the operational data;
generate an event based on the variance;
determine a financial impact of the variance based on the variance and the financial data; and
prioritize the event based on the financial impact; and
outputting the events.

13. A method according to claim 12, wherein the analyzing further comprises categorizing the event as relating to a role within the organization.

14. A method according to claim 12, wherein the analyzing comprises applying rules to the operational data and financial data to identify the variance and to determine the financial impact.

15. A method according to claim 14, wherein the rules comprise information relating to the roles within the organization and the event is categorized as being related to a role within the organization.

16. A method according to claim 14, further comprising entering configuration data, comprising the rules.

17. A graphical user interface for role-based information, the user interface comprising a plurality of icons each representing a role within an organization, wherein each icon is selectable to provide additional information relating to events relating to the role.

18. The graphical user interface of claim 17, wherein each icon also indicates a status for the represented role based on priority of the events for the represented role.

19. The graphical user interface of claim 17, wherein the additional information comprises a list of events ranked according to a financial impact of the event on the organization.

20. A graphical user interface for viewing reports comprising:
a main window;
two or more secondary windows within the main window, each secondary window showing a single report variable, wherein each secondary window comprises a means for moving the secondary window within the main window, allowing a first secondary window to be overlaid on a second secondary window in order to compare report variables.
